(19) United States
(12) Patent Application Publication
(10) Pub. No.: US 2017/0242852 A1
(43) Pub. Date: Aug. 24, 2017

(54) SYSTEM FOR ANALYZING INFORMATION, GENERATING DOCUMENTS, AND COLLABORATING WITH MULTIPLE PARTIES

(71) Applicant: Michael J. Clain, Pelham, NY (US)

(72) Inventor: Michael J. Clain, Pelham, NY (US)

(21) Appl. No.: 15/431,021

(22) Filed: Feb. 13, 2017

Related U.S. Application Data
(60) Provisional application No. 62/296,698, filed on Feb. 18, 2016.

(51) Int. Cl. G06F 17/30; G06F 9/44; G06F 17/24; G06Q 40/02; G06F 3/0482

(52) U.S. Cl. CPC G06F 17/30011; G06Q 40/025; G06F 3/0482; G06F 17/243; G06F 9/4443

(57) ABSTRACT

A system for collecting and storing information in a secure database, automatically selecting and populating documents and communicating between users and with existing databases, may include: a computer readable medium on which an application for executing an application is stored, the application may include instructions including: providing fillable forms such as information sheets and term sheets; comparing information entered on a fillable form with that on existing databases; automatically sending queries to existing databases and filling information in fillable forms based on data in the existing databases; determining documents needed for a specific task and automatically populating the documents with the information collected; and updating and communicating to a plurality of users as to a status and changes of the information in real-time.

### BACKGROUND OF THE INVENTION

Field of the Invention

The present disclosure relates generally to analyzing information, conducting due diligence, generating documents, and collaborating with multiple parties.

Description of the Related Art

Closing a commercial loan or a similar transaction (e.g., another type of debt instrument, a lease, a purchase of receivables or any other type of credit facility or enhancement) is a tedious task that requires complex analysis and the preparation of many different documents and collaboration or communication among many different parties which may be in various different locations. For example, a loan officer in New York would have to perform at least the following or similar tasks:

A) Loan Officer sends a prospect (a potential Borrower; the terms “Prospect” and “Borrower” may be used interchangeably throughout this Application) an email with two attachments for completion: a credit application (information sheet) and a list of background documents needed for credit approval.

B) Prospect fills out the information sheet and emails it back; prospect collects background documents and emails them to the Loan Officer.

C) Loan Officer reviews the information sheet and background documents and saves them to his document management system.

D) Loan Officer accesses the Treasury Department database and runs one or more OFAC (U.S. Office of Foreign Assets Control) searches against the potential Borrower and its owners and subsidiaries. Loan Officer saves the search results to his document management system.

E) Loan Officer accesses the relevant state database and reviews Borrower's corporate status. Loan Officer saves the search results to his document management system.

F) Loan Officer accesses the relevant state database and runs preliminary lien searches against Borrower. Loan Officer saves the search results to his document management system.

G) Loan Officer accesses the USPTO website and runs patent and trademark searches against Borrower. Loan Officer saves the search results to his document management system.

G-1) Loan Officer prepares a preliminary credit memorandum for review by the underwriting department, in which he describes the prospect, its industry and the proposed loan terms.

G-2) The underwriter assigned to the Loan Officer reviews the memorandum and, if the content of the memorandum conforms to pre-determined criteria, grants preliminary approval.

H) Loan officer prepares a proposal letter that includes a term sheet setting forth the approved loan terms and emails it to Borrower.

I) Borrower prints out the proposal letter, signs it, scans it, emails it back to Loan Officer, and sends a good faith deposit to Loan Officer by check or wire OR Borrower reviews proposal letter, calls Loan Officer to negotiate the terms, and the parties repeat steps G1 through H.

J) Once step I is completed, Loan Officer orders formal lien searches, good standing certificates, certified corporate documents, company reports, credit reports, and investigative reports online, by email or by phone from various service providers.

K) Loan Officer receives the lien search results and the documents and reports he has ordered online, by email or by phone from various service providers and saves the received reports in his document management system.

K-1) Following a review of all documents, Loan Officer prepares a formal credit approval memorandum for review by his institution's credit committee, in which he describes the prospect, its industry and the proposed loan terms.

K-2) The credit committee reviews the memorandum and if the content of the memorandum conforms to pre-determined criteria, approves the loan.

L) Loan officer prepares and signs a commitment letter that includes a term sheet setting forth the approved loan terms and emails it to Borrower.

M) Borrower prints out the commitment letter, signs it, scans it and emails it back to Loan Officer OR Borrower reviews the commitment letter and attached term sheet, calls Loan Officer to negotiate the terms, and the parties repeat steps K-1 through L.

N) Loan Officer sends commitment letter, term sheet and credit approval memo to his/her lending institution's Lender's Counsel.

O) Lender's Counsel (a) prepares a list of closing documents based on his expertise and the information in the term sheet; (b) locates appropriate templates or precedents for the documents he deems necessary for closing the credit facility; (c) modifies the templates/precedents to reflect the term sheet; and (d) emails initial drafts of loan documents to the Loan Officer for review.

P) Loan Officer reviews the drafts and provides comments to Lender's Counsel.

Q) Lender's Counsel revises drafts to reflect Loan Officer's comments and emails them to Borrower and its counsel.

R) Borrower's Counsel communicates his comments to Lender's Counsel by phone or email (which may include a mark-up of the loan documents).

S) Lender's Counsel revises drafts to reflect Borrower's Counsel's comments and emails revised drafts to all the parties. The process is repeated until all the parties are satisfied with the substance of the documents.

T) Borrower and Borrower's Counsel email documents they need to provide to Lender's Counsel and coordinate with third parties Borrower has engaged (such as title agents, insurance brokers and current lenders) to email documents under their control to Lender's counsel. Lender's Counsel circulates an updated list of closing documents periodically to indicate status.

U) Lender's Counsel keeps parties apprised of documentation status by email and periodic circulation of updated closing lists.

V) Parties approve final drafts.

W) Lender's Counsel emails signature pages to all the parties.

X) Each party prints out its signature pages, signs them, scans one set, emails pdf copies to Lender's Counsel and returns the originals to Lender's Counsel.

Y) Lender's Counsel prints the pdf copies of the signature pages and the documents to which they belong, compiles fully signed counterparts, scans them in and emails them to all the parties. Lender's Counsel advises Lender by email that all the closing conditions have been met or waived.

Z) Lender's Counsel receives the hard copies of the signature pages, prints out the documents to which they belong, adds the other documents delivered for the closing and distributes closing sets.

AA) Each party is responsible for maintaining its own set of closing documents. No party has access to any other party's database.

BB) Lender establishes and maintains a tickler file that notifies appropriate parties when it is time for Borrower to comply with applicable periodic reporting requirements (such as the delivery of borrowing base certificates and financial statements) or take actions to protect its liens (such as continuing financing statements before they expire). Lender runs additional lien and corporate status searches when it deems it necessary (not necessarily an automatic process).

As can be appreciated, this process includes many steps, requires many decisions to be made, and is time-consuming as it is performed manually. Accordingly, a more streamlined and efficient system and method of performing at least the above would be desirable.

The background section is provided by way of illustration and is not to be construed as constituting prior art unless otherwise stated herein.

### SUMMARY OF THE DISCLOSURE

The present invention is directed to a method and a system of automatically making determinations and automatically generating documents on demand, and alerting all the parties when new documents are delivered, particularly with respect to commercial transactions that involve the electronic transmission of documents among two or more parties. The present invention is further directed to a system for such transactions, where the system may expand beyond a single institution's system and engage third party providers, these providers selected based on a series of pre-implemented criteria, where the criteria can be user-specific and user-controllable.

The system of the present invention preferably comprises a hub-and-spoke arrangement where the hub includes one or more servers in communication with one or more data stores. The spokes are preferably data paths for communication between users, between each user and the hub, and between a user or the hub and third parties. In the preferred embodiment, the system is offered to users as software-as-a-service and platform-as-a-service and the users each access the system using a web browser or as an app. The users who subscribe to the system can customize some of the functionality and appearance of the system through the browser, and the system's functionality and/or appearance may differ based on the type of user. As envisioned herein, the types of users may include lenders and borrowers, receivables purchasers and suppliers, vendors and their customers, landlords and tenants, buyers and sellers of real property, goods or services, and professional advisors such as legal counsel. That is, the principals to a contract, where the contract ordinarily requires one or both sides to provide background information and/or documents, and their professional advisors would be typical users. In at least some embodiments, different graphical user interfaces (GUIs) can be provided for different types of users. For example, a borrower and a lender can be provided with different GUIs with different fillable information. Further, different parties within a borrower or a lender organization can have distinct GUIs based on their anticipated or completed contributions to the process. In at least one embodiment of the present invention, the GUIs are automatically updated as new data are received and analyzed, where the update could include status updates. In other embodiments, the GUIs may be customizable—for example, the view for one loan transaction might be arranged differently by a user relative to a different loan transaction.

The GUI of the present invention serves multiple purposes. It provides a real time snapshot of the status of the transaction and can provide a party such as a lender with an overview of all pending or completed transactions. It also serves as a conduit for information. For example, based on a work flow for a transaction, the GUI allows users to input or modify content and forward documents for storage, such as so as to create a compendium of documents. It also serves as a means for formulating queries to third parties, such as to a third-party for a lien search. Upon information being returned from a third party, such information can be stored yet be visible on the GUI of the present invention. The content of information received can automatically be analyzed so as to identify discrepancies or the need to revise or modify the process flow. The GUI can additionally be used as a vehicle for accepting an electronic signature. The GUI also provides a means for rapid human interaction—for example, a loan officer can review a file for completeness or be authorized to make changes in drafts or even request additional documents. The GUI also provides a messaging medium—for example, a lender can use the GUI to notify a potential borrower of additional documents needed to close the transaction by listing the documents on its own portal and having the system dynamically modify the potential borrower's portal to add the new documents and notify the potential borrower of the change; or a potential borrower can use the GUI to notify a potential lender of a document delivery by uploading the document to the system and having the system dynamically modify the potential lender's portal to indicate that the document has been uploaded and is available for review and notify the potential lender of the new status of the document.

As described herein the present invention is advantageous over the current approaches as it: A) increases transparency because the system of the present invention keeps all of the relevant parties apprised of information submission and document production necessary for credit approval, closing and administration; B) provides for real-time verification of accuracy of information; C) automatically searches relevant databases; D) improves Cybersecurity (no documents travel by email; all document transmissions take place between individual parties and the Presently disclosed system database); E) provides for Antivirus protection (since no documents are sent directly from one party to another, they cannot infect the intended recipient's computer system; Presently disclosed system database will have enterprise level antivirus protection); F) provides the opportunity for internal controls (requiring Loan Officer to follow predetermined workflow, limiting choices available to Loan Officer when completing a Term Sheet or requiring approval for terms outside the Lender's norm) and guidance (included in a dropdown menu of default values, order of preference, or internal intelligence); G) allows for single entry of information for multiple uses (borrower's name is entered by Prospect and used (a) to run various database searches, (b) to complete the Term Sheet, (c) to generate proposal letter, and (d) to generate documents); it increases efficiency and reduces opportunities for error; H) provides for automatic document management (eliminates the need for the Loan Officer or Lender's Counsel to save email attachments to document management systems); I) provides for automatic document selection (app determines what documents are necessary for closing given the values entered by the Loan Officer in the Term Sheet); and document assembly (system assembles documents based on the values specified in the Term Sheet); J) provides for communal archiving (all parties continue to have access to the closing documents in the Presently disclosed system database, avoiding loss/misplacement of documents and unnecessary requests for copies of various documents); K) provides for automatic rules-based ongoing monitoring; and L) provides for data collection and analysis.

In at least one embodiment, the system of the present invention sends reminders to parties regarding completion of tasks and resets schedules for document delivery and reminders for recurring tasks, such as financial reporting.

In a representative embodiment of the present disclosure, a system for implementing a method of collaboration and document generation may include any or all of the following steps, sequenced as appropriate:

Step 1: Loan Officer sends a prospect an introductory email, which contains a link to a portal for use by the prospect to access the presently disclosed system.

Step 2: Prospect registers on the presently disclosed system prospect portal and logs in. The prospect portal is on a server in the cloud and is accessed by the prospect through its browser. The prospect portal contains a fill-in-the-blank information sheet and a list of documents required by the Loan Officer for credit approval. Next to each document name there is an upload button that allows the prospect to upload documents from his computer directly into the presently disclosed system database.

Step 3: Prospect fills out electronic information sheet through the prospect portal. In at least one embodiment, access is provided using a Graphical User Interface (GUI) that is accessible through a browser that is running on a smart phone, tablet, or personal computing device; said device in communication with at least one server and at least one data store; with, at least in part, selectable menu items.

Step 4: As the Prospect provides information, the system provides the information to a secure server and the server runs searches when it has sufficient information to do so (e.g., when the Prospect enters the name of his/her company and

State of organization, the system runs a corporate status search in the database of the relevant State; when the Prospect enters any name—borrower, owners, management—the system runs a search against that name in the OFAC database).

Step 5: The app notifies Lender (such as by email or text) and through Lender's portal when the status of a document has changed (e.g., information sheet is in progress or a document has been uploaded or downloaded).

Step 6: The server allows the Lender to view through its portal the information entered by the prospect in the information sheet as it is keyed in.

Step 7: As the prospect enters data in the information sheet, such as the name of his company, the app shows the Prospect a list of options it has found in a relevant database and asks him to pick the correct one (e.g., if prospect enters “AAA Realty”, app will ask him whether he means AAA Realty and Management Inc., AAA Realty Corp., or AAA Realty I Partners, LLC); the choice made by the Prospect will replace the name he entered in the information sheet. If the app/server cannot find the name entered by the Prospect in the relevant database, it will alert him and ask him to enter the correct name.

Step 8: Based on analysis of entered data, the Lender may determine other documents are needed. If the Lender desires to add to the list of documents it requires from the Prospect for credit approval, he can simply add the name of the additional document he requires on his portal and the app will automatically notify the Prospect (such as by email or text) and through the Prospect portal of the new requirement.

Step 9: The system automatically runs several types of free searches (including corporate status, liens, OFAC and USPTO) against all the parties named in the information sheet (main operating company, subsidiaries and owners) and stores the results under the appropriate designation in the Due Diligence tab. The system notifies the Loan Officer (such as by email or text) and through the Lender's portal that due diligence results are available for viewing.

Step 10: Prospect completes remaining portions of the information sheet and clicks Submit. The information sheet content is stored in a secure database. System (subsequent use of the term “App” is understood to mean that the function may be accomplished by a server instead) notifies Loan Officer both by email and through the Lender's portal that the information sheet has been submitted and is available for viewing.

Step 11: Prospect uploads background documents, which are stored in a secure database. Each time a document is uploaded, the app notifies Loan Officer by email or text and through the user portal that a new document has been uploaded and is available for viewing.

Step 12: Loan Officer reviews information sheet (which has been converted to a viewable/printable form by the app), other background documents and due diligence results.

Step 13: Loan Officer authorizes automatic completion of content of a term sheet or fills it out him/herself. Data entered on the information sheet is entered in the term sheet via dropdown menus and autosync. Loan Officer's choices (e.g., interest rates, types and amounts of fees, financial covenants) can be limited—or preferred terms can be specified—by a person with administrative rights.

Step 14: When Loan Officer has completed the term sheet, he clicks a button and a proposal letter in the standard format of the Loan Officer's institution, containing the terms set forth in the term sheet, is generated by the app. Loan Officer opens and reviews it, makes any desired revisions and, when satisfied, clicks Send. The proposal letter is saved to a secure database and the Prospect is notified by email and through the prospect portal that the proposal letter is available for viewing.

Step 15: Prospect signs proposal letter digitally (and also prints out, signs, scans and uploads a “hard” copy if the Loan Officer requires it). The app notifies the Loan Officer by email and through the Lender's portal that the proposal has been signed and is available for viewing.

Step 15A: Prospect makers an initial good faith payment via deposit via credit card, ACH transfer or other means through the interface. The app notifies the Loan Officer preferably by email or text and through Lender's portal that payment has been made.

Step 16: Loan Officer orders requisite documents from outside organizations, including formal lien searches, good standing certificates, certified corporate documents, credit reports and investigative reports from various service providers by filling out a universal order form under the Due Diligence tab. Data entered by the Prospect in the information sheet is available on the order sheet via dropdown menus and autosync. The app sends the orders to the vendors chosen by the Lender or to a set of vendors chosen by the app on the basis of a formula that takes into account a variety of factors, including price, prior performance and user reviews.

Step 17: The lien search results and the documents and reports the Loan Officer has ordered are uploaded by the various service providers into a secure database and available to Loan Officer for viewing under the Due Diligence tab.

Step 18: Loan Officer clicks Drafts; the app selects the documents necessary for the closing based on built-in logic using proprietary algorithms and the data in the information sheet and the term sheet, lists all the documents under the Documents tab and generates initial drafts of the documents to be provided by Lender.

Step 19: Loan Officer clicks Send; the app opens a dialog box in which Loan Officer can choose (a) documents to send and (b) to whom they should be sent (e.g., Lender's Counsel, Borrower or Borrower's counsel); Loan Officer clicks Select All and Lender's Counsel.

Step 20: App notifies Lender's Counsel by email that documents are now available for viewing.

Step 21: Lender's Counsel clicks on link in email, registers and then logs in to her own portal; if counsel has done business with Lender using presently disclosed system she already has an account and need not register.

Step 22: Lender's Counsel reviews proposal and drafts on her own portal, makes any necessary changes, uploads the revised drafts, then clicks Send, picks Select All and Loan Officer as the addressee. The revised drafts are stored in a secure database and Loan Officer receives an email advising him that the revised documents are available for review.

Step 23: Loan Officer reviews the drafts and provides comments to Lender's Counsel. App offers Loan Officer a choice of reviewing clean copies of documents or copies redlined to show changes made by Lender's Counsel.

Step 24: Lender's Counsel revises drafts to reflect Loan Officer's comments, uploads the revised drafts, clicks Send, then chooses Select All and Borrower and Borrower's Counsel to send the documents to Borrower and its counsel.

Step 25: Drafts are stored in a secure database. Borrower and its Counsel receive notification by email and, in the case of Borrower, through its portal.

Step 26: Borrower logs into his portal to view the drafts. Email sent to Borrower's Counsel contains a link to a separate portal for the presently disclosed system. Borrower's counsel clicks on link in email, registers with presently disclosed system and logs into her portal to view the drafts.

Step 27: Borrower's counsel provides comments to Lender's Counsel.

Step 28: Lender's Counsel revises drafts to reflect Borrower's Counsel's comments, uploads them and clicks Send, then selects the documents to send and picks Loan Officer, Borrower and Borrower's Counsel as the addressees; Loan Officer, Borrower and Borrower's Counsel receive notification by email and through their respective portals. The process is repeated until all the parties are satisfied with the text of the documents.

Step 29: Borrower's Counsel uploads documents it is required to provide (e.g., legal opinion) through her portal, Borrower uploads documents it is required to provide (e.g., copies of leases) through its portal and insurance broker uploads documents it is required to provide (e.g., certificate of insurance) through his portal (created through the same process as the other portals—an email from Lender or Lender's Counsel with an embedded link which leads to a registration page; once he enters his email address and chosen password, he gains access to a login page and through it to his dedicated portal with access limited to the documents he needs to view and/or provide); each time a document is uploaded the app notifies all the parties with whom the person uploading the documents chooses to share them (e.g., Loan Officer, Lender's Counsel, Borrower and Borrower's Counsel) by email and through that party's dedicated portal that the new documents have been uploaded and are available for viewing.

Step 30: App keeps all parties' portals in sync so everyone is aware of documentation status.

Step 31: Parties approve final drafts.

Step 32: Lender's Counsel clicks on Execution Copies, completes information in the dialog box, then clicks on Generate Documents; the app generates execution copies containing the document dates, addresses for notices and name and title of signatory provided by Lender's Counsel in the dialog box; Lender's Counsel clicks Send, selects documents to send and parties to send them to and sends documents to be signed.

Step 33: App saves the execution copies to a secure database and notifies all the parties by email and through their portals that the documents are available for signature. The app generates an additional document (the “Signature Page Document”) that contains only signature pages to the Execution Copies.

Step 34: Parties sign their documents digitally and, in addition, print out the Signature Page Document, sign the necessary number of copies and return the hard copies to Lender's Counsel.

Step 35: App notifies all the parties by email and through their respective portals that all the documents have been executed digitally and all the closing conditions have been satisfied or waived (either automatically or upon permission by Loan Officer or Lender's Counsel).

Step 36: Lender's Counsel receives the hard copy of the Signature Page Document, prints out the documents to which the signature pages belong, adds the other documents delivered for the closing and distributes closing sets.

Step 36A: Lender's Counsel sends the UCC financing statements generated by the app to its chosen vendor for filing. When it receives it back from the filing office, vendor uploads a file-stamped copy of the UCC financing statements to the secure database. The app notifies Lender's Counsel by email and through the app that the file-stamped copy has been uploaded.

Step 37: Loan Officer moves Prospect's name to the Client tab; Borrower and Borrower's Counsel continue to have access to their documents; Loan Officer continues to have access to all the client information/due diligence/documentation for his clients; Lender's management and legal staff continue to have access to the client information/due diligence/documentation for all clients of the Lender; Lender's Counsel continues to have access to all the client information/due diligence/documentation for all the transactions she closed for Lender.

Step 37A: Loan Officer fills out a tickler tab on which he schedules all the items that need to be provided periodically by the Borrower (such as financial reporting) or need action by the Lender (such as new lien searches or continuation of UCC filings), the dates and frequency of reporting or action, the party responsible for taking the relevant action, and whether the Loan Officer wants the responsible party notified and if so how many days in advance of the required action.

Step 38: On the dates specified by the Loan Officer the app automatically sends the responsible party a reminder email specifying the action required and the date it is due.

Step 38A: If the required action is running new lien searches or continuing UCC filings, the app automatically runs or orders the searches and prepares and files the necessary continuation statements in the appropriate jurisdictions.

Step 39: App offers knowledge management (e.g., Loan Officer wants to know if anybody in his institution has done deals in the trucking industry) and market intelligence to its subscribers (the latter on an aggregated, anonymous basis) (e.g., a Lender wants to know what financial covenants are customary in the for-profit education sector; or counsel wants to know what percentage of lenders using the present system have modified their loan agreements to deal with Art. 55 of the EBRD).

A system for automatically populating documents and communicating between users, may include: a computer readable medium on which an application for executing an application is stored, the application in communication with a server associated with a memory store, said server in communication with parallel implementations of said application on other platforms, the application may include instructions including: providing a fillable information sheet; comparing information entered on the information sheet with that on existing databases; automatically filling information in the information sheet based on data in the existing databases; determining documents needed for a specific task and automatically populating the documents with the information collected; ordering documents or other information from third parties; and updating and communicating to a plurality of users as to a status and changes of the information in real-time.

It is to be understood that unless indicated otherwise herein, the present disclosure is not limited to the specific ordering of the steps described herein. Lenders may have different workflows, require different information and documents from their prospects and offer different loan terms on their term sheets. The app is designed to be easily customizable by users with no knowledge of coding for their particular needs.

The above and other aspects, features and advantages of the present disclosure will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a glossary of symbols used throughout the flowcharts of the other figures;

FIGS. 2A-2F is a flowchart illustrating an operation in accordance with the present disclosure;

FIGS. 3A-3X are screenshots illustrating various steps in the operation of FIGS. 2A-2F;

FIG. 4A illustrates a network environment in which an electronic device operates according to various embodiments of the present disclosure;

FIG. 4B is a block diagram illustrating an electronic device according to various embodiments of the present disclosure; and

FIG. 4C is a block diagram illustrating a program module according to various embodiments.

### DETAILED DESCRIPTION OF THE PREFERRED EMBODIMENTS

Hereinafter, various embodiments of the present disclosure are described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

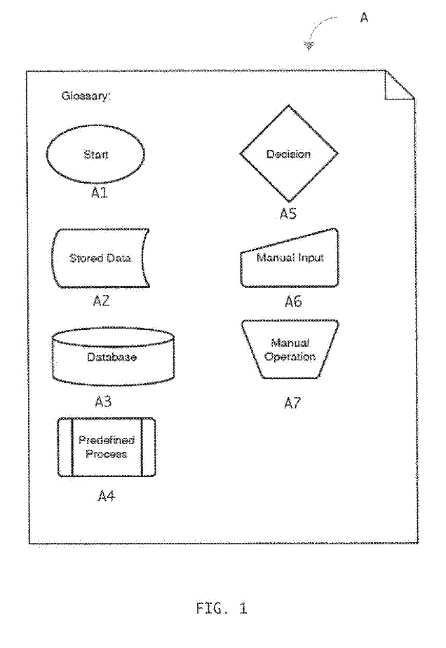

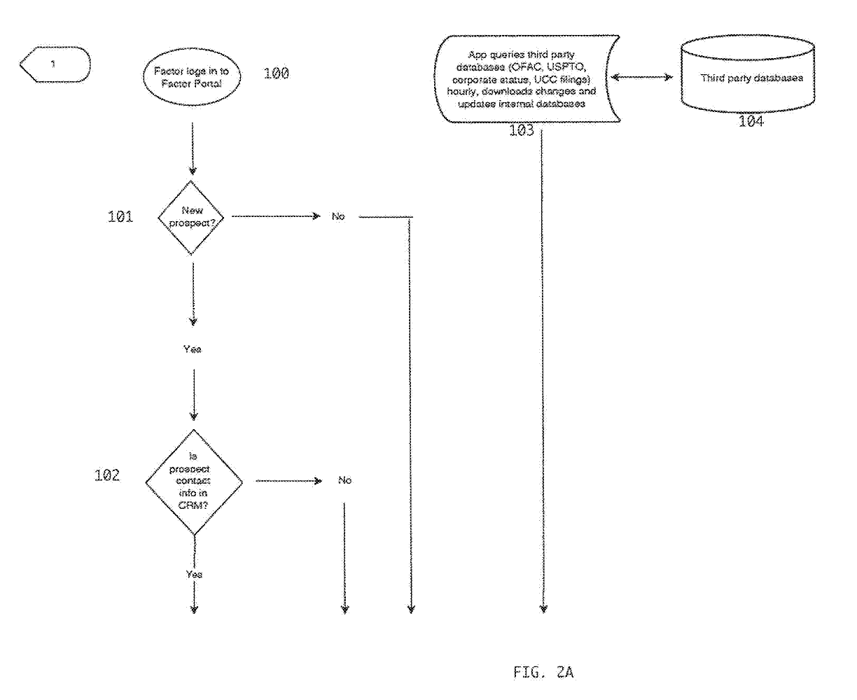

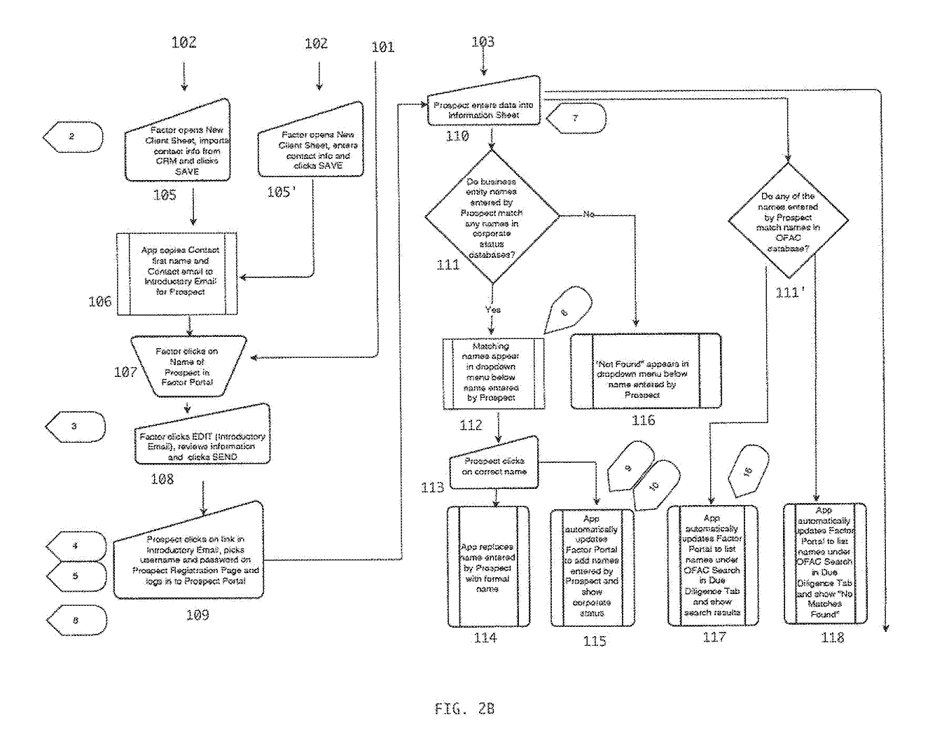

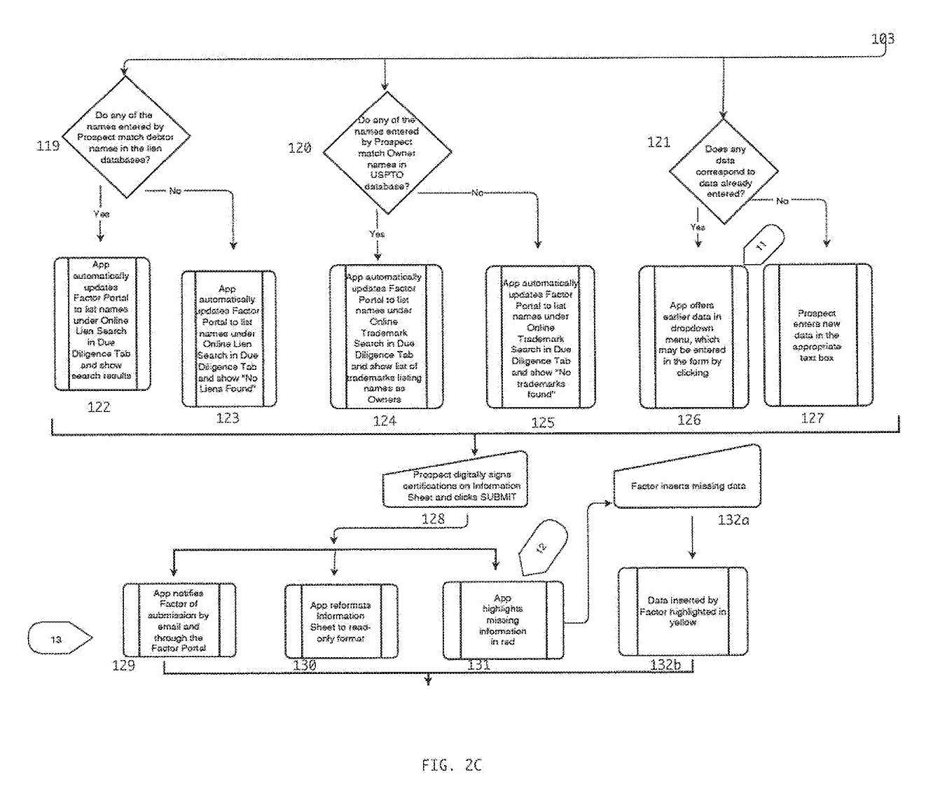

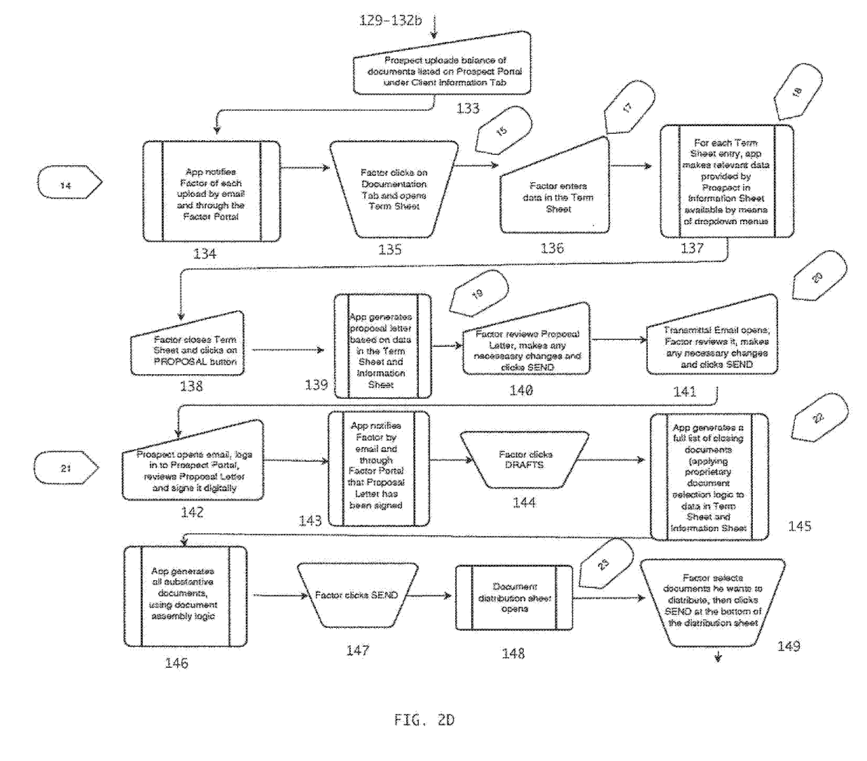

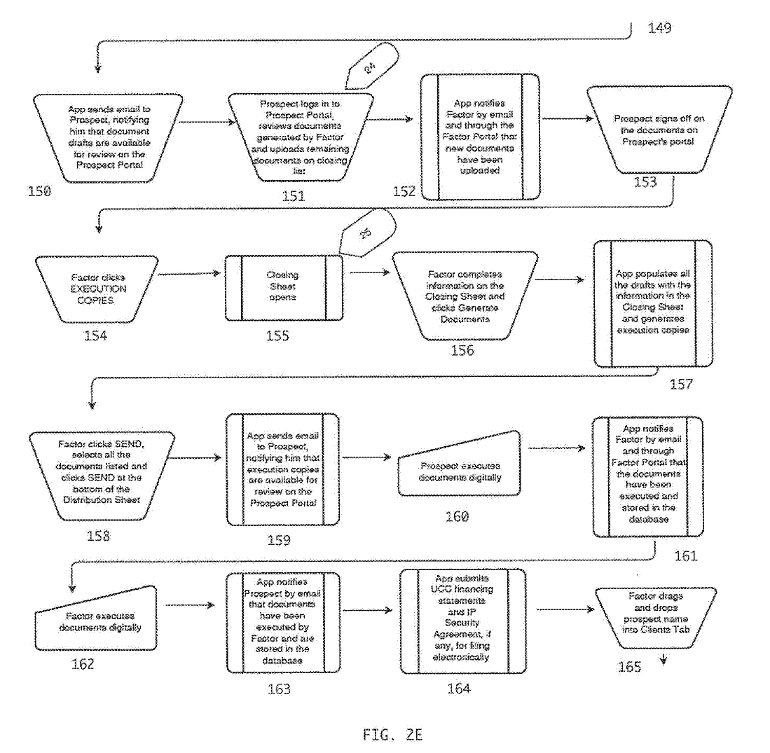

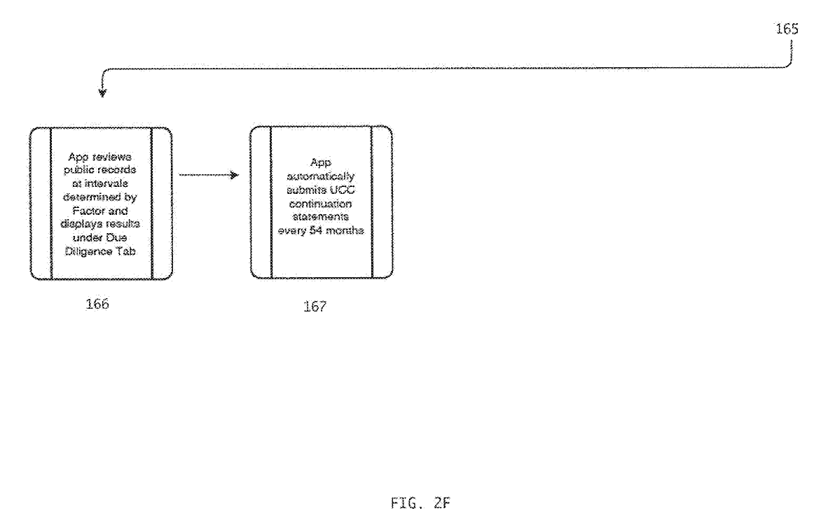

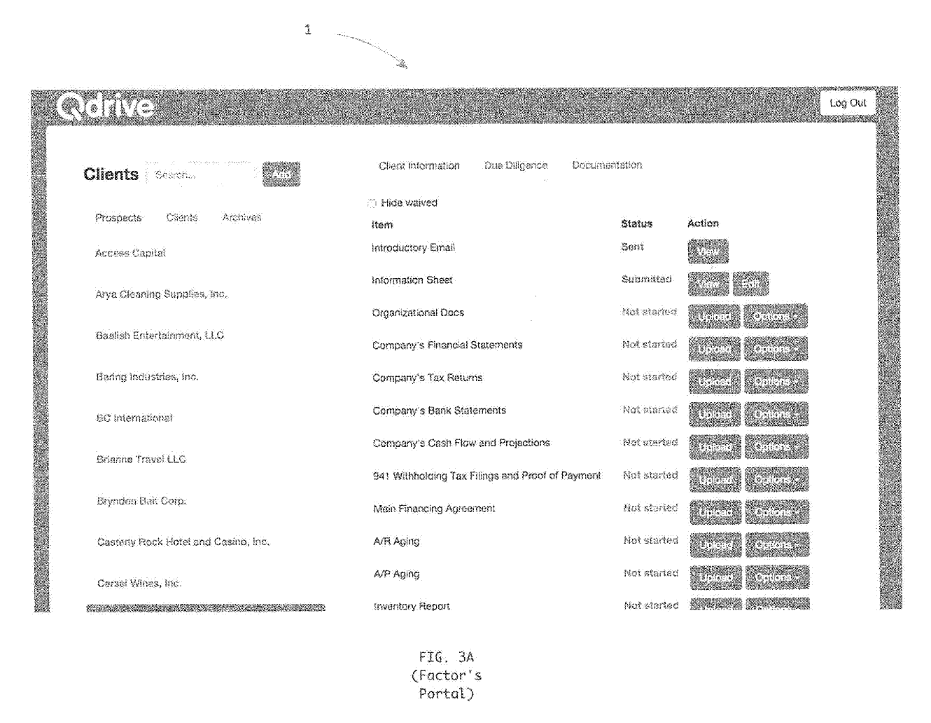

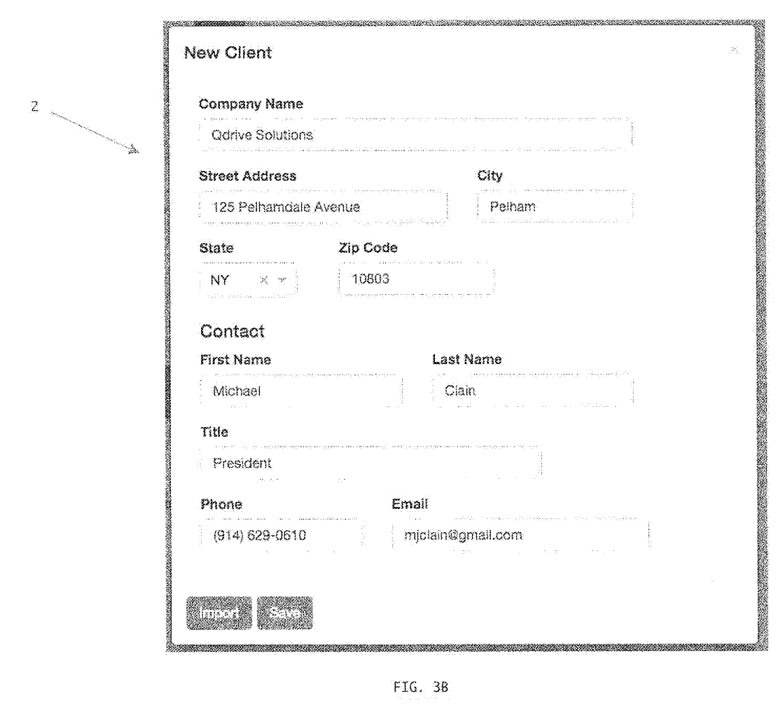

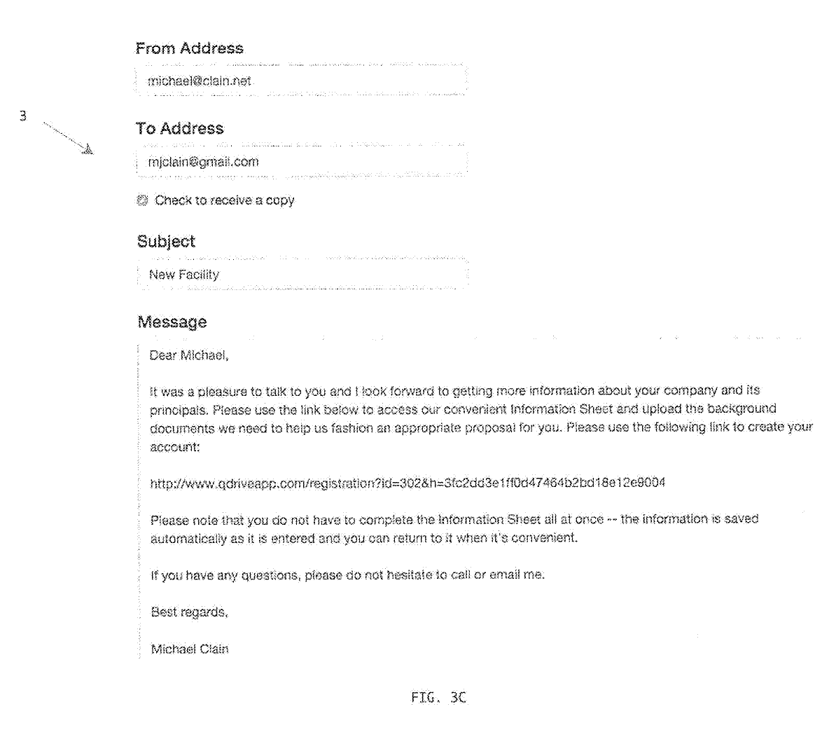

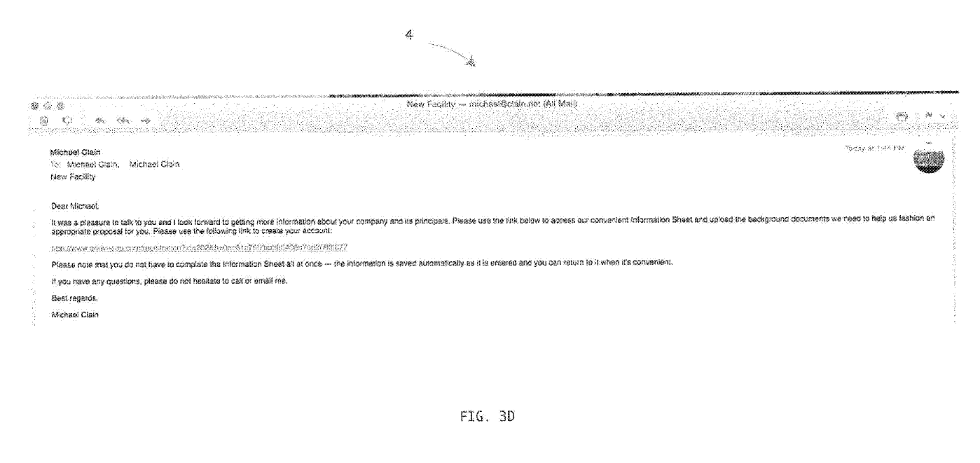

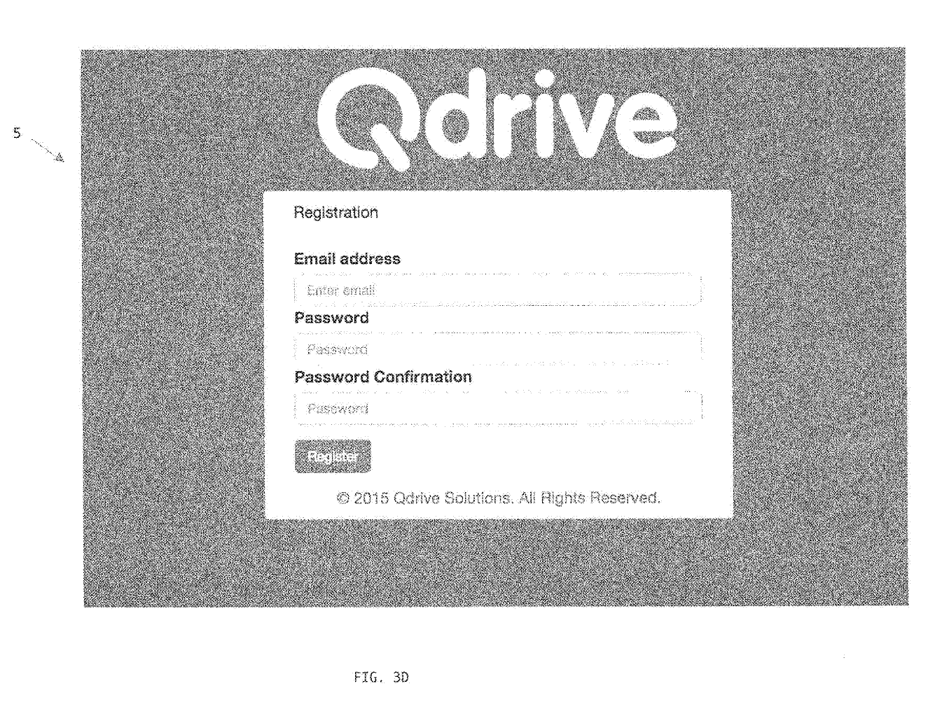

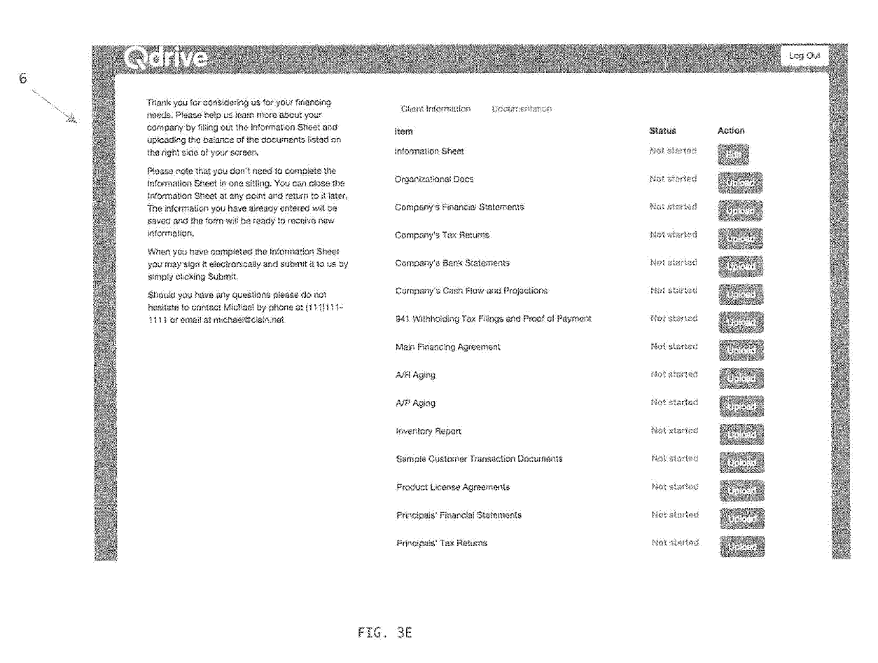

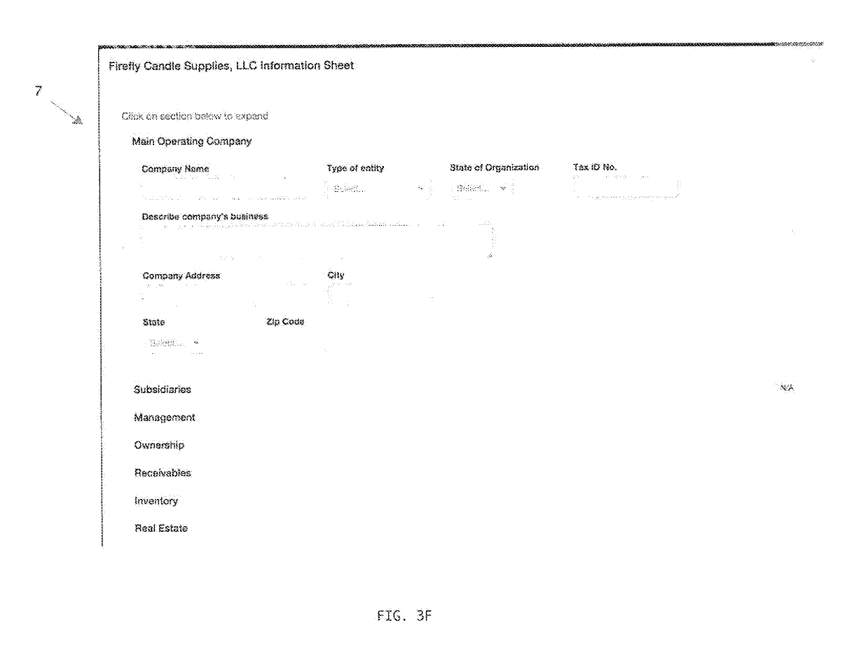

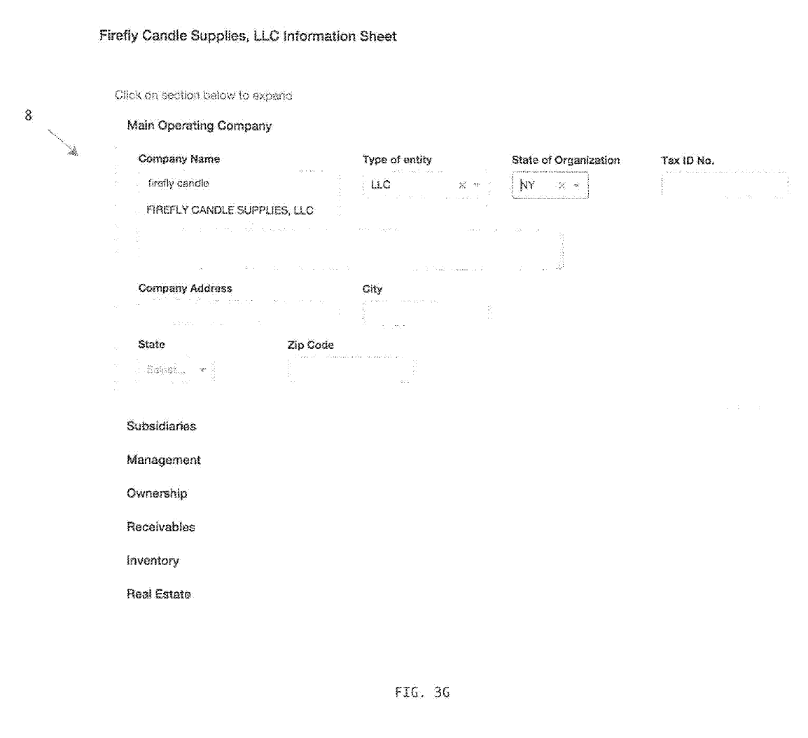

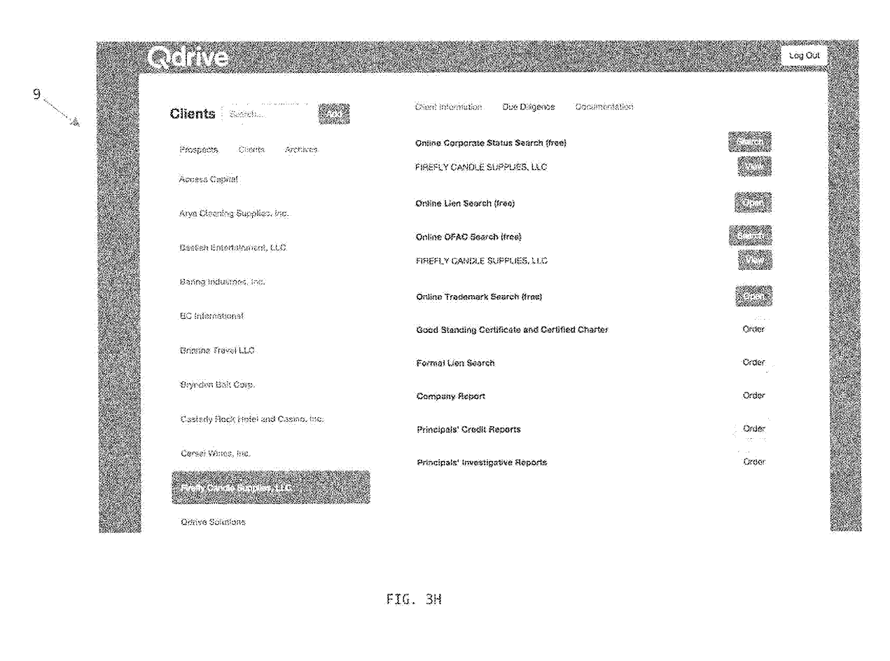

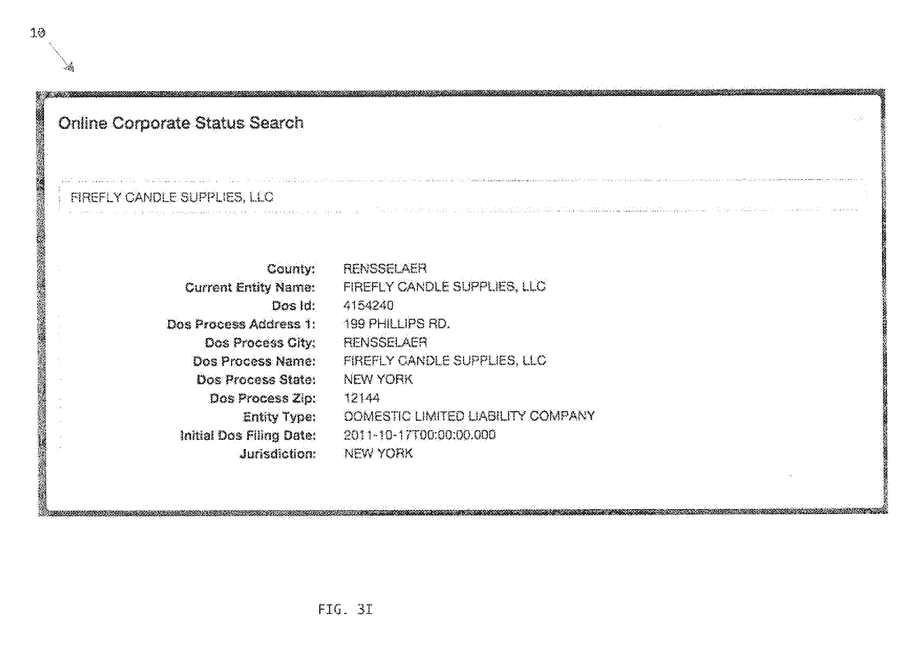

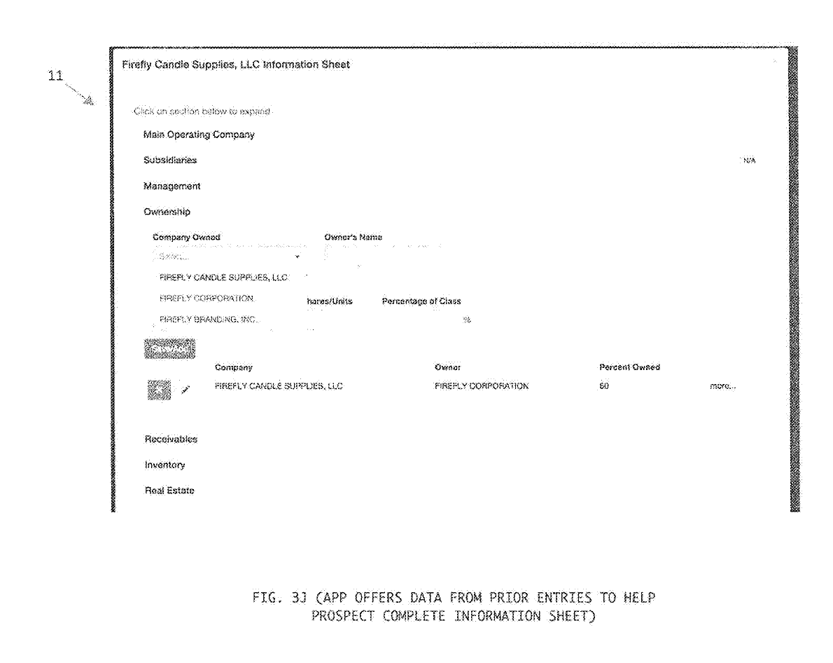

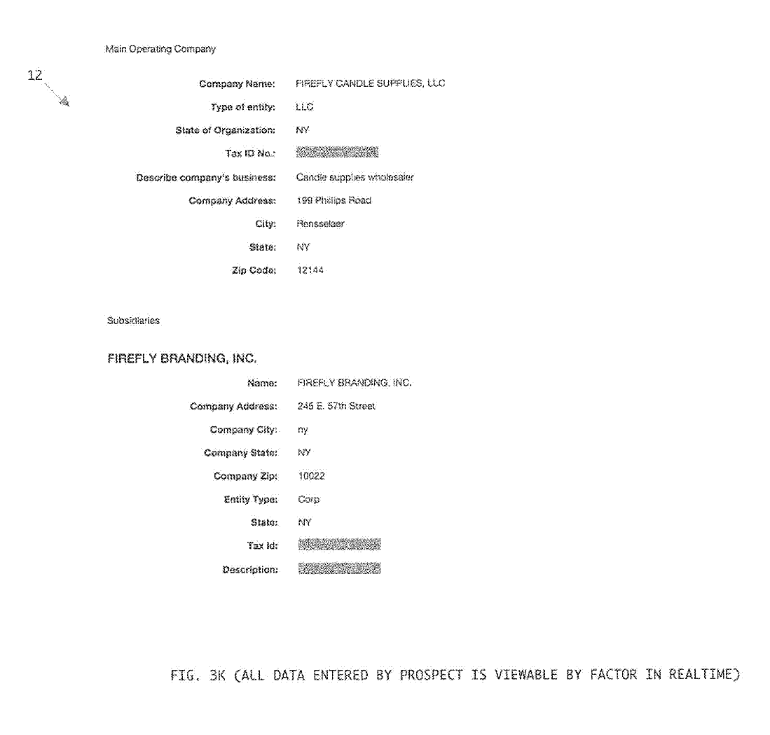

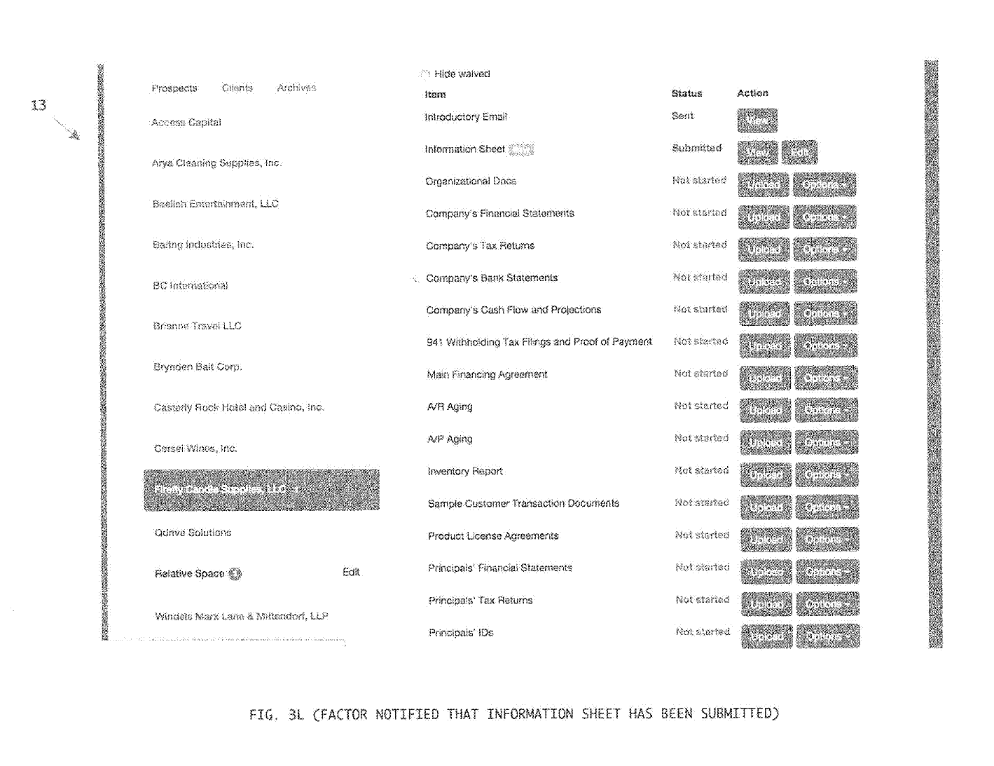

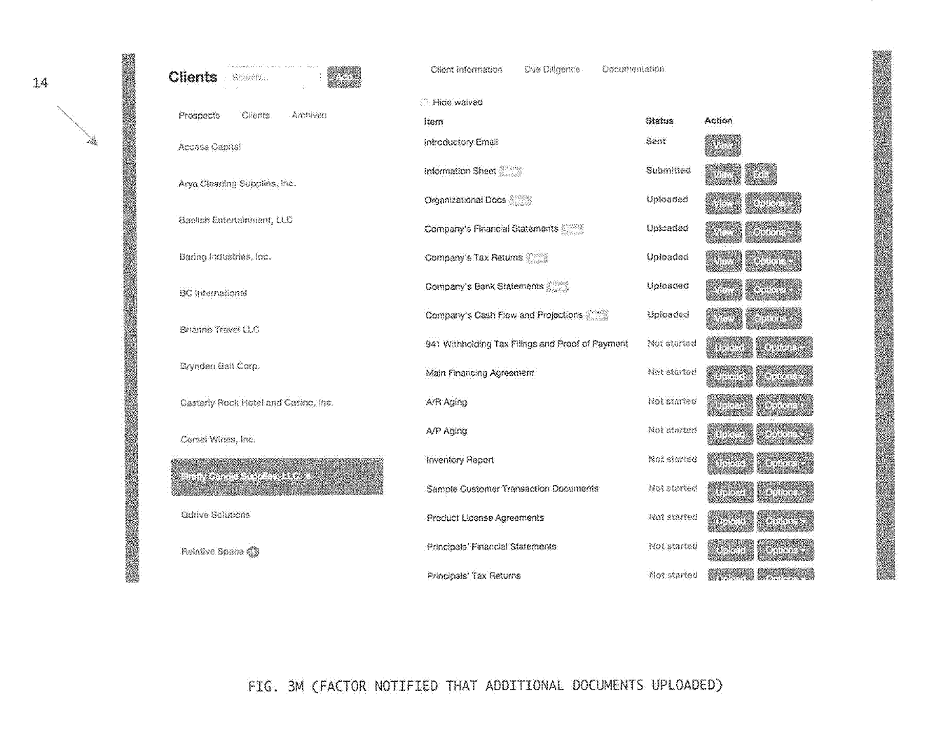

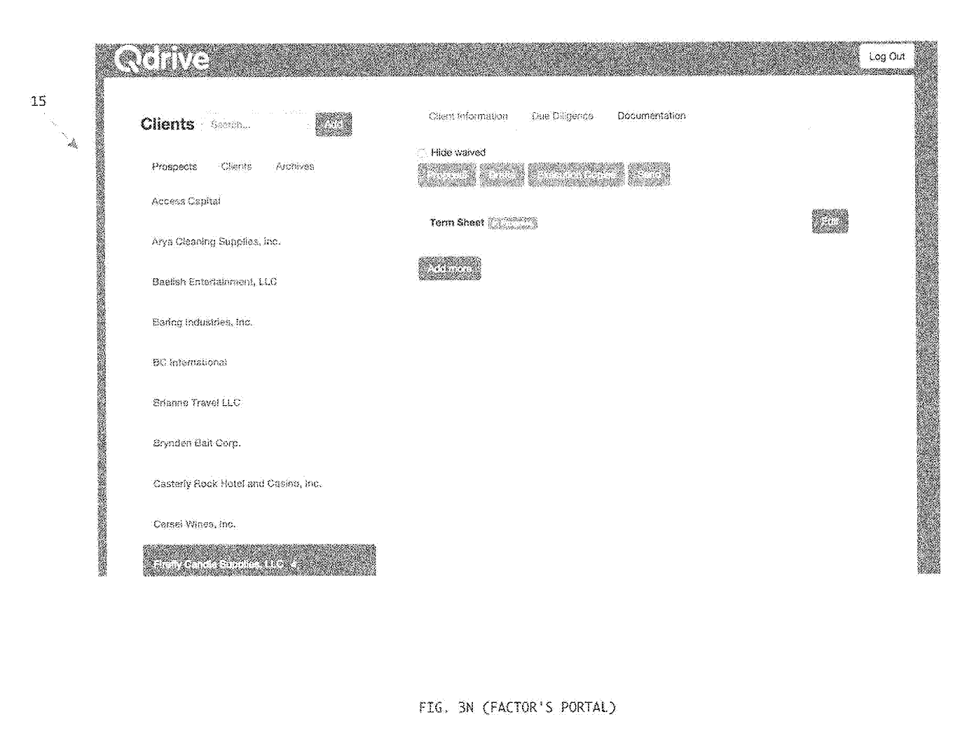

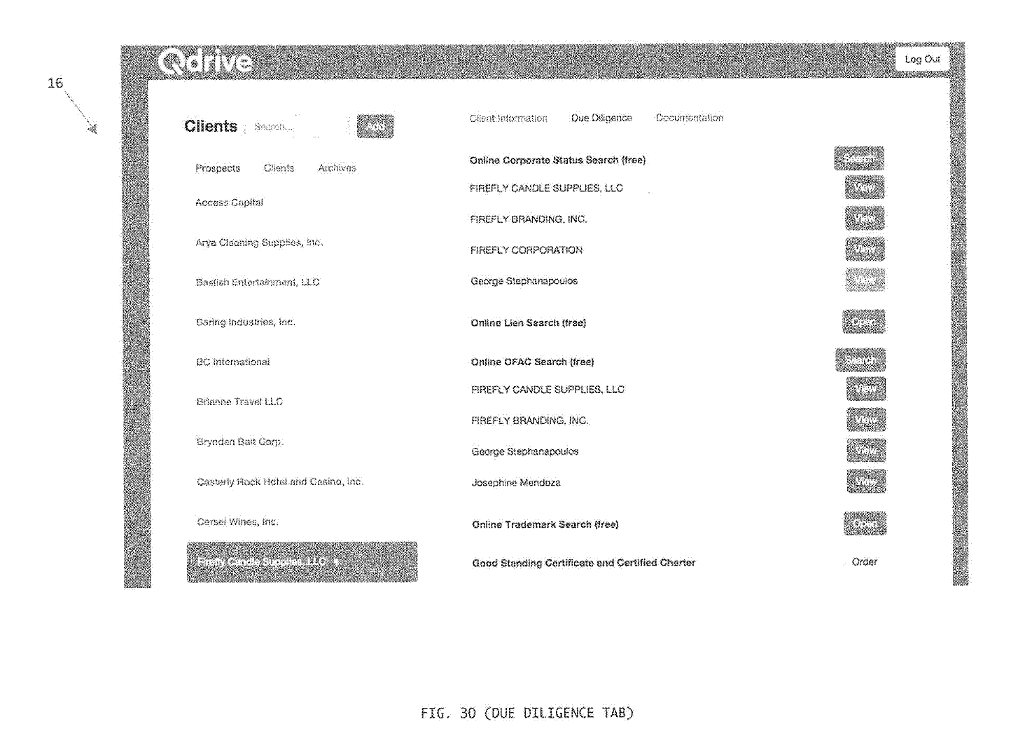

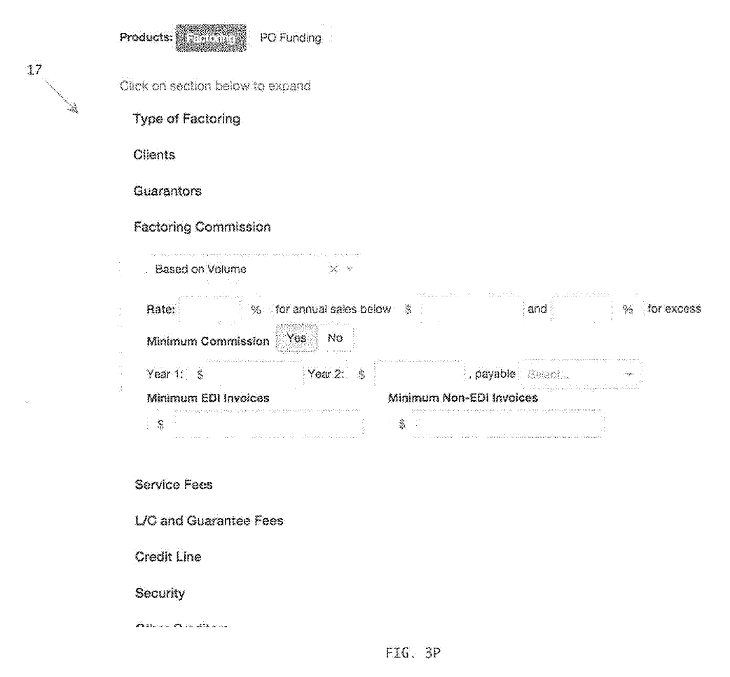

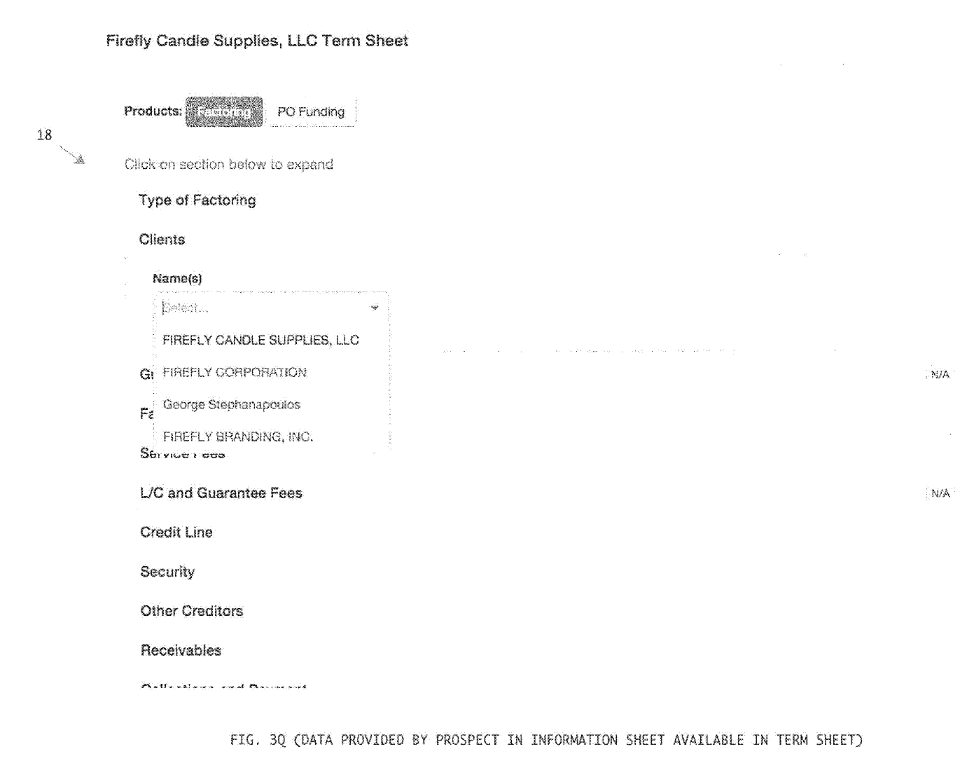

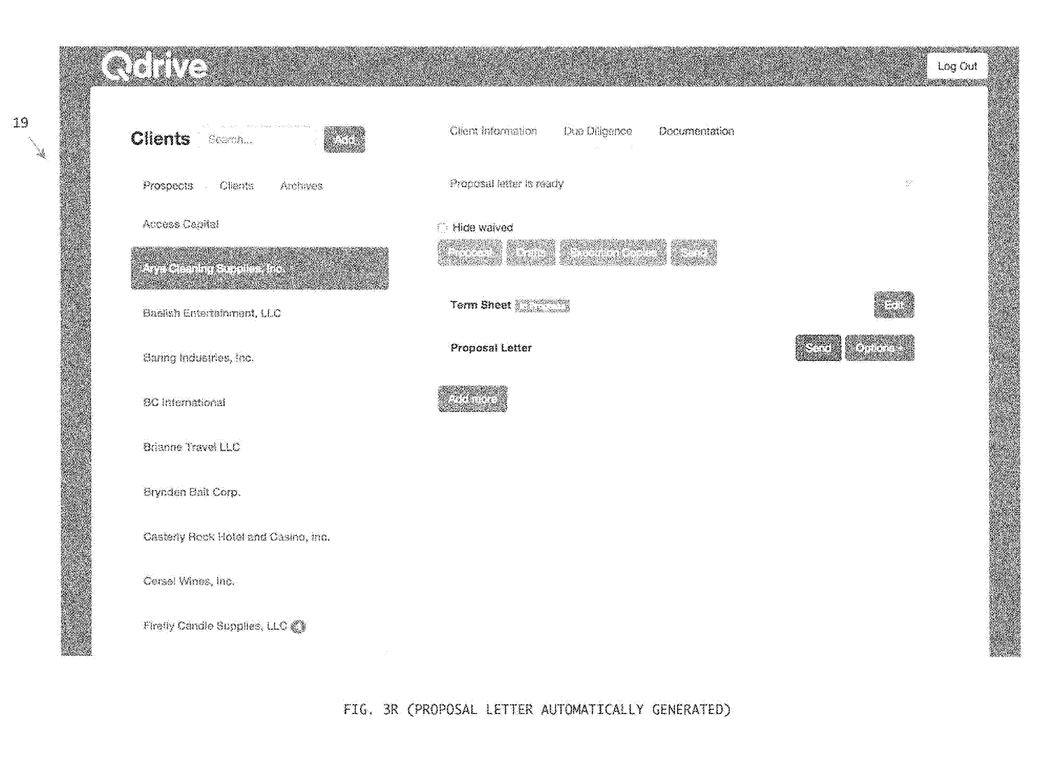

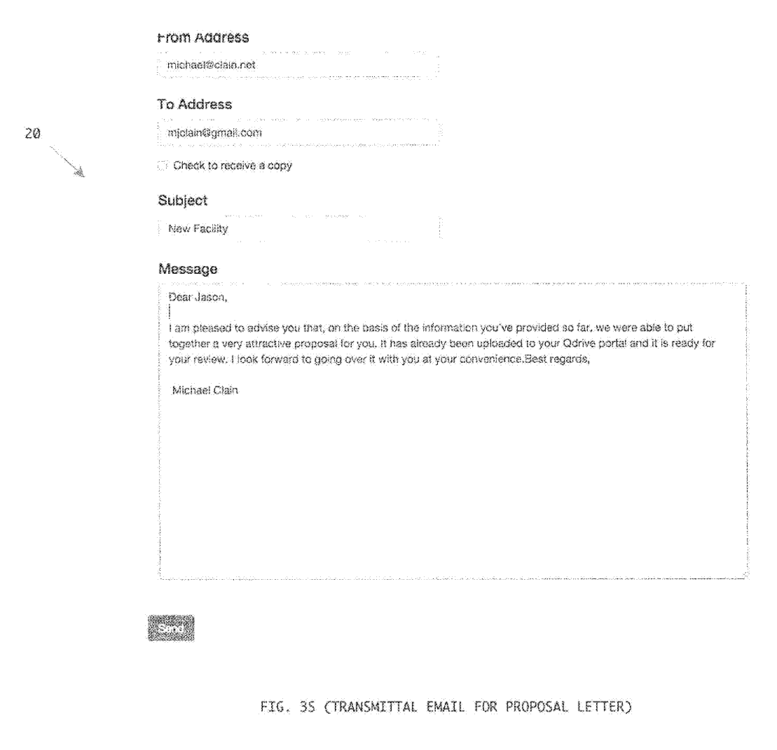

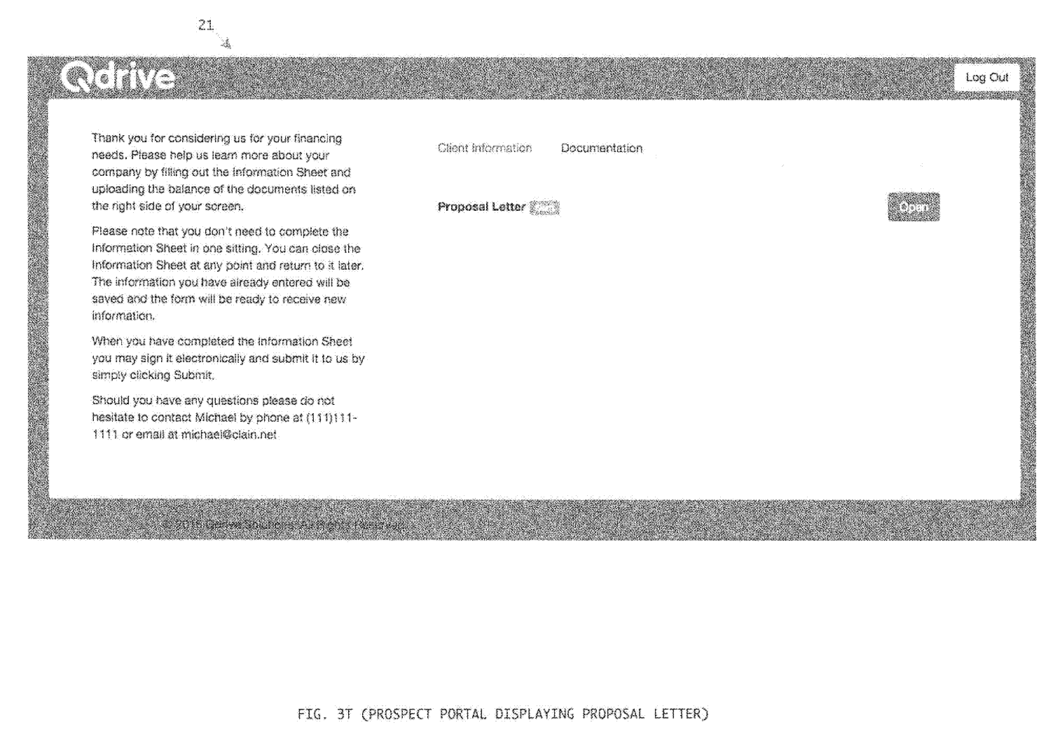

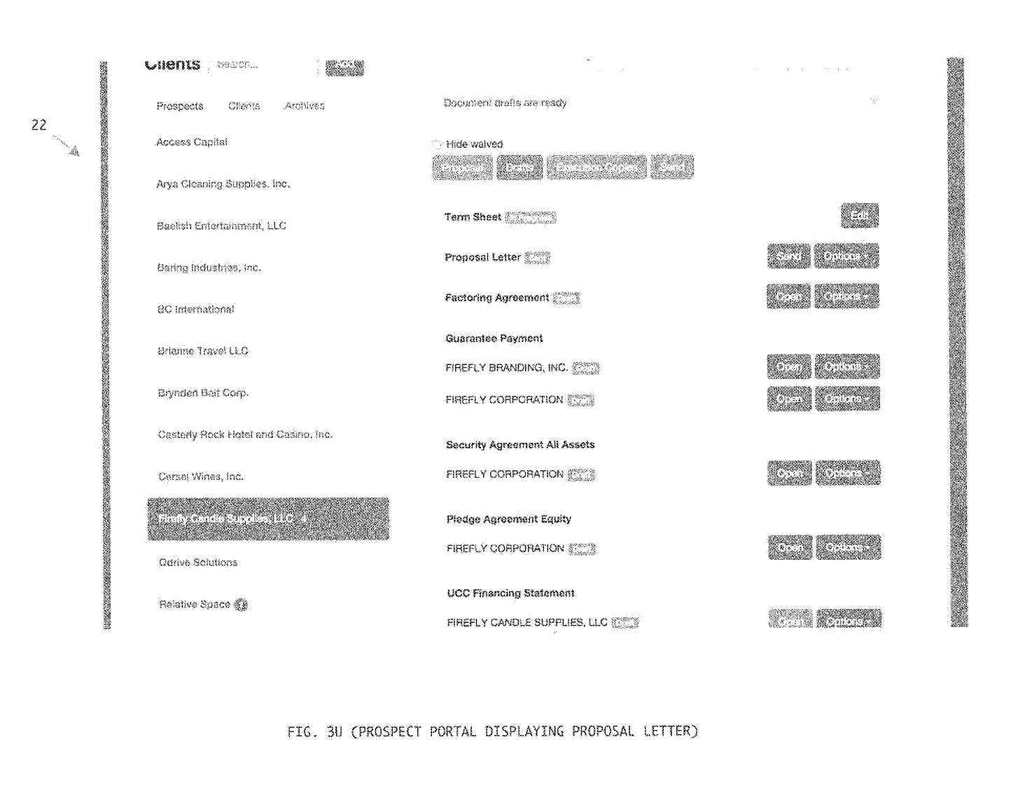

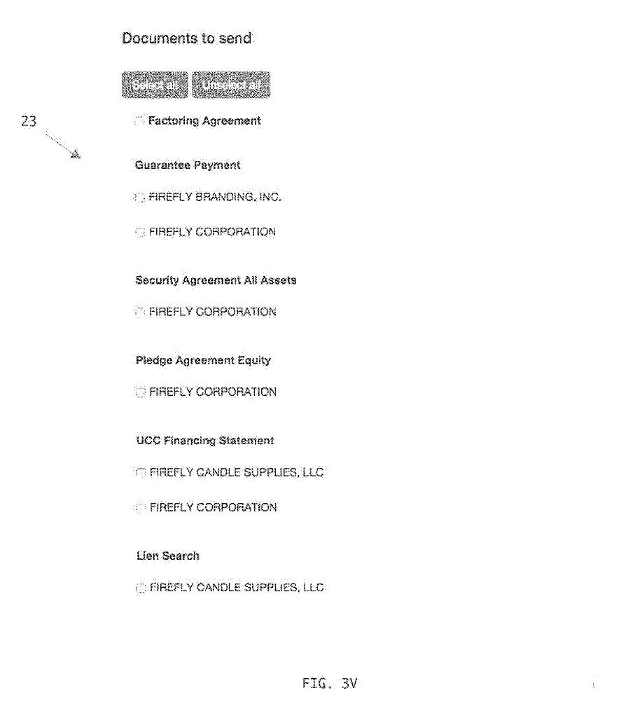

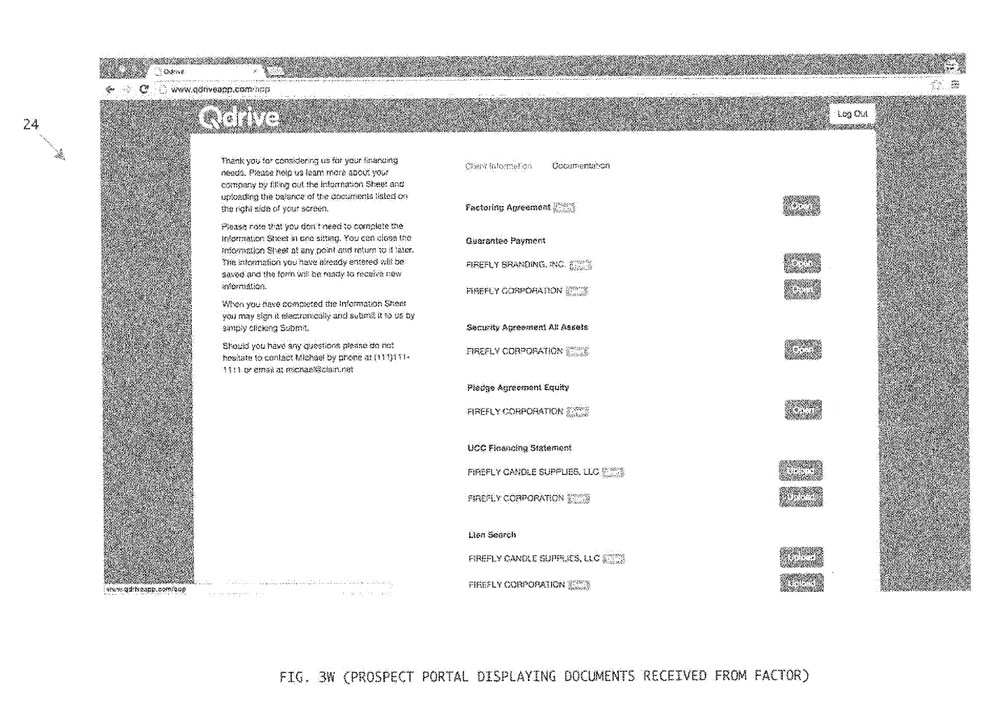

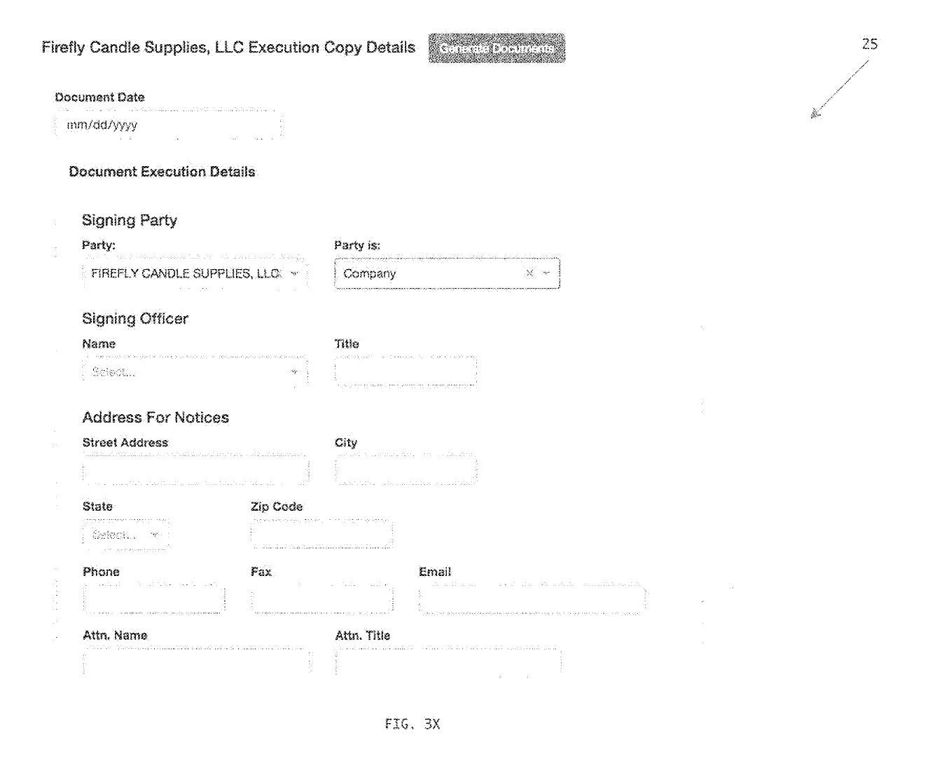

FIG. 1 depicts a glossary key A to aid in understanding the flowcharts disclosed herein in which A1 represents the start of an operation, A2 represents stored data, A3 represents a database, A4 represents a predefined process, A5 represents a decision, A6 represents a manual input, and A7 represents a manual operation. FIGS. 2A-2F collectively depict a flowchart for implemented an operation on a computer system. Throughout the flowchart illustrated in FIGS. 2A-2F, various element numbers 1-25 are labeled which correspond with screenshots illustrated in FIGS. 3A-3X depicting the operation step identified in the flowchart of FIGS. 2A-2F.

Referring to FIGS. 2A-2F, at step 100 lender may log into a factor portal. The factor may then be presented with a query at step 101 as to whether the prospect is new. If yes, proceed to step 102 and if not proceed to step 107. At step 102, a query is made as to whether the prospect contact information is in the Client Relationship Management software (CRM), e.g., SALESFORCE, MICROSOFT OFFICE, and APPLE CONTACTS. If the prospect's contact information is already in the CRM software, it can be imported into the presently disclosed system without having to retype or reenter it. In addition, at steps 103 and 104, the application or system queries third party databases for information including for example, assignment records at the USPTO or UCC filings, etc. Depending on whether the information is already stored, the factor may open a new client sheet, import contact information at step 105a or the like or such information may be entered manually at step 105′ if not already stored in another application. At step 106, the presently described system (referred to as an “app” in the flowcharts) may copy contact first name and email into an introductory email for an introductory email for prospect. At step 107, the factor may click on the name of the prospect in the factor portal. At step 108, the favor may click edit (introductory email), review information and send. At step 109, the prospect may access the link in the introductory email, pick a username and password on prospect registration page and log into the prospect portal. At step 110, the prospect may enter data into the information sheet. At step 111, a query may determine whether the business entity name match with any names in a database. If yes, matching names may be shown or a message may be displayed to the user that no similar names were found. At step 111′ names of the prospect may also be compared to names in other databases such in the OFAC (The Office of Foreign Assets Control of the US Dept. of the Treasury) database. If the business entity has matching names in a corporate status database, at step 112, matching names appear in a dropdown menu, if not, at step 116, the dropdown menu will display “not found”. At step 113, the prospect can click on the correct name and in response, at step 114 the app may replace the name entered by the prospect with its formal name or at step 115, the app may automatically update the factor portal. At steps 117 and 118, respectively, in response to the query as to whether the names entered by the prospect appear in the OFAC database, the app may automatically update factor portal to list names under OFAC search in a due diligence tab and show the search results or automatically update factor portal to list names under OFAC Search in Due Diligence Tab and show “no matches found.”

In addition, in response to the prospect entering data into the information sheet, at steps 119-121, several queries may be made including at 119 as to whether any of the names entered by the prospect match debtor names in the lien database, at 120 as to whether any of the names entered match owner names in the USPTO database, at 121 as to whether any data correspond to data already entered, and at 121 as to whether any data corresponds to already entered data. If at step 119 there are matching names found in the lien database, at step 122, the app may automatically update factor portal to names under the online lien search in the due diligence tab and show search results, and if not, at step 123, the app may automatically update factor portal to show that no liens were found. If at step 120, matching names were found in the USPTO database, at step 124, the app automatically update factor portal to list names under the Online Trademark Search in the due diligence tab, and if not, at step 125, the app may automatically update factor portal to show that no trademarks were found. If at step 121, data is found to correspond to data already entered, earlier data may be offered in a dropdown menu at step 126 or at step 127, new data may be entered. Thereafter, the prospect may digitally sign certifications on information sheet and may submit. At steps 129-131, respectively, app may notify the factor of submission, reformat information sheet to a read-only format, and may highlight missing information which the factor may enter at 132a and which may be indicated to others as being added at step 132b. Thereafter, at step 133, the prospect may upload the balance or remainder of documents listed on the prospect portal under the client information tab. At step 134, the app may notify the factor of each upload by email and through the factor portal. At step 135, the factor may select documentation tab and open term sheet, at step 136, the factor may enter data in the term sheet. At step 137, for each term sheet entry, the app may make relevant data provided by the prospect in the information sheet available by means of one or more dropdown menus. The factor may close term sheet and click proposal button at step 138, and the app may generate proposal letter based on the data in the term sheet and the information sheet at step 139. At step 140, the factor may review proposal letter and make any necessary changes and may then select send so that at step 141, a transmittal email may be opened for the favor to review and make any necessary changes. Thereafter, at step 142, an email may be sent to the prospect for review and signature. At step 143, the app may notify the favor by email and through factor portal that a proposal letter has been signed. At step 144, the factor may click on the drafts. At step 145, a full list of closing documents may be presented or displayed. At step 146, the app may generate all the substantive documents using document assembly logic. At step 147, the factor may approve the documents to be sent and at step 148, a document distribution sheet may be opened. At step 149, the factor may select documents he wants to distribute and then may confirm or approve that the documents be sent. Thereafter, at step 150, an app may send an email to the prospect to notify him that document drafts are available for review on the prospect portal. At step 151, the prospect may log into the prospect portal, review the documents generated by factor and upload remaining documents on closing list. At step 152, the app may notify the factor by email and through the factor portal that new documents have been uploaded. At step 153, the prospect may sign off on the documents on the prospect's portal. At step 154, the factor may select execution copies. At step 155, a closing sheet may open. At step 156, the factor may complete information on the closing sheet and may allow documents to be generated. At step 157, the app may populate all of the drafts with provided in the closing sheet and may generate execution copies. At step 158, the factor may select all the documents listed and may have then sent (which may include making them available and does not necessarily refer to sending them in an email or the like). At step 159, an email may be sent to notify the prospect of the availability of the execution copies for review on the Prospect Portal. At step 160, the prospect may execute the documents digitally. At step 161, the app may notify the factor via email and through Factor Portal that the documents have been executed and stored in the database. At step 162 the factor may execute documents digitally. At step 163, the app may notify prospect by email that documents have been executed by factor and are stored in the database. At step 164, the app may submit UCC financing statements and IP security agreement, if any, for filing electronically. At step 165, the factor may drop the prospect name into the client's tab. At step 166, the app may review public records at intervals determined by factor and display results under due diligence tab. At step 167, app may automatically submit UCC continuation statements at a predetermined interval such as every 54 months.

The specific embodiment above is merely illustrative of a particular use and is not limited thereto. As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific details disclosed herein are merely representative, yet in that regard, they are deemed to afford the best embodiment for purposes of disclosure and to provide a basis for the claims herein that define the scope of the present invention.

Reference will now be made in detail to several embodiments of the invention that are illustrated in the accompanying drawings.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the figures may be implemented in a combined configuration of hardware, software, and/or networking technologies. No claim element herein is to be construed under the provisions of 35 U.S.C. 112, sixth paragraph, unless the element is expressly recited using the phrase “means for”.

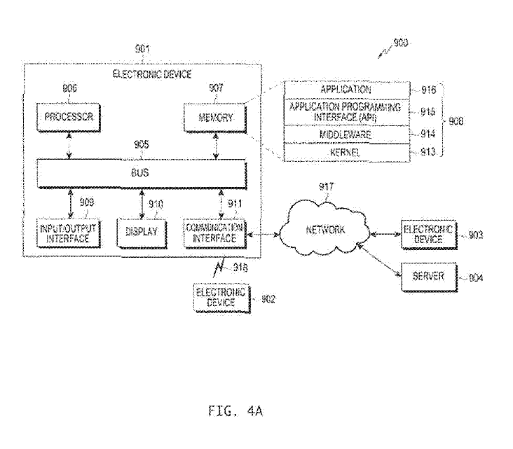

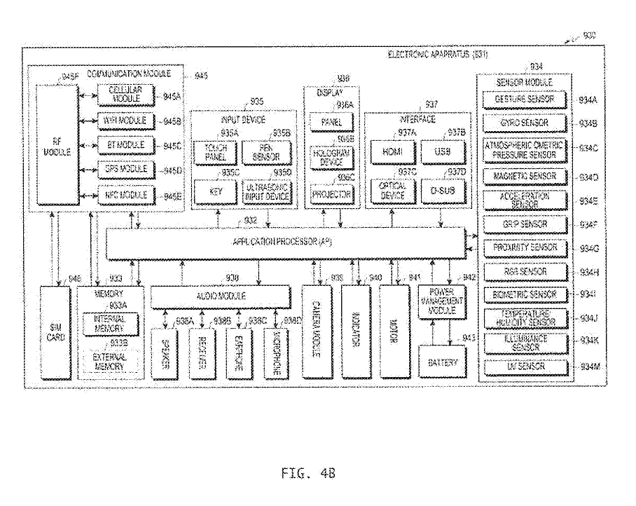

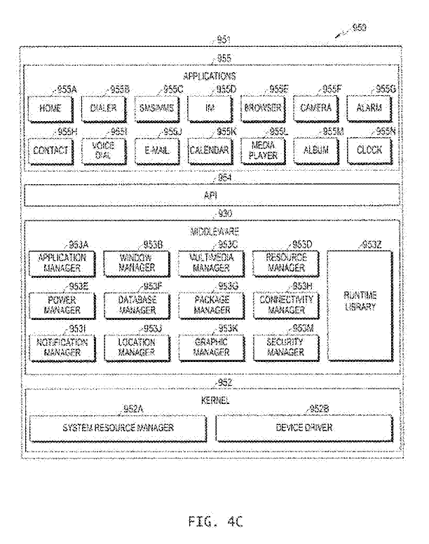

Referring to FIG. 4A, an electronic device on which the above described system or method may be implemented is depicted. Within a network environment 900 according to various embodiments will be described. An electronic device 901 may include a bus 905, a processor 906, a memory 907, an input/output interface 909, a display 910, and a communication interface 911. In some embodiments, the electronic device 901 may omit at least one of the above components or additionally include other components. The bus 905 may include, for example, a circuit for connecting the components 905 to 911 to each other and transferring communication (for example, a control message and/or data) between the components. The processor 906 may include one or more of a Central Processing Unit (CPU), an Application Processor (AP), and a

Communication Processor (CP). The processor 906 may control, for example, one or more other components of the electronic device 901 and/or process calculation or data related to communication. The memory 907 may include a volatile memory and/or a non-volatile memory. The memory 907 may store, for example, instructions or data related to at least one other component of the electronic device 901. According to an embodiment, the memory 907 may store software and/or a program 908. The program 908 may include, for example, a kernel 913, middleware 914, an Application Programming Interface (API) 915, and/or an application program (or “application”) 916. At least some of the kernel 913, the middleware 914, and the API 915 may be referred to as an Operating System (OS). The kernel 913 can, for example, control or manage system resources (e.g., the bus 905, the processor 906, the memory 907, etc.) used for executing an operation or function implemented by the other programs (e.g., the middleware 914, the API 915, or the application program 916). Further, the kernel 913 can provide an interface through which the middleware 914, the API 915, or the application program 916 may access individual components of the electronic device 901 to control or manage system resources. The middleware 914 can, for example, serve as a relay for allowing the API 915 or the application program 916 to communicate with the kernel 913 to exchange data. Further, with regard to task requests received from the application program 916, the middleware 914 can, for example, make a control (e.g., scheduling or load balancing) for the task requests using a method of assigning at least one application a priority for using the system resources (e.g., the bus 905, the processor 906, or the memory 907) of the electronic device 901. The API 915 is, for example, an interface through which the applications 916 control functions provided from the kernel 913 or the middleware 914, and may include, for example, at least one interface or function (for example, instructions) for file control, window control, image processing, or text control. The input/output interface 909 can, for example, serve as an interface through which commands or data input from the user or another external device can be transmitted to other component(s) of the electronic device 901. Further, the input/output interface 909 can output instructions or data received from another component(s) of the electronic device 901 to a user or another external device. The display 910 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 910 can display various types of contents (for example, text, images, videos, icons, or symbols) for users. The display 910 may include a touch screen and can, for example, receive a touch input, a gesture input, a proximity input, or a hovering input using an electronic pen or a user's body part. For example, the communication interface 911 can configure communication between the electronic device 901 and an external device (for example, a first electronic device 902, a second electronic device 903, or a server 904). For example, the communication interface 911 can be connected to a network 917 through wireless or wired communication to communicate with the external device (for example, the external electronic device 903 or the server 904). The wireless communication can use, for example, at least one of LTE, LTE-A, CDMA, WCDMA, UMTS, WiBro, and GSM, for example, as a cellular communication protocol. The wired communication may include, for example, at least one of a Universal Serial Bus (USB), a High Definition Multimedia Interface (HDMI), Recommended Standard 232 (RS-232), and a Plain Old Telephone Service (POTS). The network 917 may include at least one of communication networks such as a computer network (for example, a LAN or a WAN), the Internet, and a telephone network. Each of the first and second external electronic devices 902 and 903 may be a device which is the same as or different from the electronic device 901. According to an embodiment, the server 904 may include a group of one or more servers. According to various embodiments, all or some of the operations performed in the electronic device 901 can be executed in another electronic device or a plurality of electronic devices (e.g., the electronic devices 902 and 903 or the server 904). According to an embodiment, when the electronic device 901 should perform some functions or services automatically or in response to a request, the electronic device 901 can make a request for performing at least some functions relating thereto to another device (e.g., the electronic device 902 or 903 or the server 904) instead of performing the functions or services by itself or additionally. The other electronic device (for example, the electronic device 902 or 903 or the server 904) can execute the requested function or the additional function and transfer the result obtained by executing the function to the electronic device 901. The electronic device 901 can process the received result as it is or additionally to provide the requested functions or services. To this end, for example, cloud computing, distributed computing, or client-server computing technology may be used.

FIG. 4B is a block diagram 930 illustrating an electronic device 930 according to various embodiments of the present disclosure. The electronic device 931 may include, for example, all or some of the electronic device 901 illustrated in FIG. 4A. The electronic device 931 may include at least one Application Processor (AP) 932, a communication module 945, a Subscriber Identification Module (SIM) card 946, a memory 933, a sensor module 934, an input device 935, a display 936, an interface 937, an audio module 938, a camera module 939, a power management module 942, a battery 943, an indicator 940, and a motor 941. The AP 932 can, for example, control a plurality of hardware or software components connected thereto by operating an operating system or an application program and perform a variety of data processing and calculations. The AP 932 may be embodied as, for example, a System on Chip (SoC). According to an embodiment of the present disclosure, the AP 932 may further include a Graphical Processing Unit (GPU) and/or an image signal processor. The AP 932 may include at least some of the components (for example, a cellular module 945A) illustrated in FIG. 4B. The AP 932 can load instructions or data, received from at least one other component (for example, a non-volatile memory), in a volatile memory to process the loaded instructions or data, and can store various types of data in a non-volatile memory. The communication module 945 may have a configuration equal or similar to the communication interface 910 of FIG. 4A. The communication module 945 may include, for example, a cellular module 945A, a Wi-Fi module 945B, a BT module 945C, a GPS module 945D, an NFC module 945E, and a Radio Frequency (RF) module 945F. The cellular module 945A can, for example, provide a voice call, a video call, a text message service or an Internet service through a communication network. According to an embodiment, the cellular module 945A may distinguish and authenticate the electronic device 931 within a communication network using a subscriber identification module (for example, the SIM card 946). According to an embodiment of the present disclosure, the cellular module 945A can perform at least some of the functions which can be provided by the AP 932. According to an embodiment, the cellular module 945A may include a Communication Processor (CP). Each of the Wi-Fi module 945B, the BT module 945C, the GPS module 945D, or the NFC module 945E may include, for example, a processor for processing data transmitted/received through the corresponding modules. According to any embodiment, at least some (two or more) of the cellular module 945A, the Wi-Fi module 945B, the BT module 945C, the GPS module 945D, and the NFC module 945E may be included in one Integrated Chip (IC) or IC package. The RF module 945F can, for example, transmit/receive a communication signal (for example, an RF signal). The RF module 945F may include, for example, a transceiver, a Power Amp Module (PAM), a frequency filter, a Low Noise Amplifier (LNA) or an antenna. According to another embodiment, at least one of the cellular module 945A, the Wi-Fi module 945B, the BT module 945C, the GPS module 945D, and the NFC module 945E can transmit/receive an RF signal through a separate RF module. The SIM card 946 may include a card including a subscriber identification module and/or an embedded SIM, and contain unique identification information (for example, an Integrated Circuit Card Identifier (ICCID)) or subscriber information (for example, an International Mobile Subscriber Identity (IMSI)). The memory 933 may include, for example, an internal memory 1522 and an external memory 1524. The internal memory 933A may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash memory (for example, a NAND flash memory or a NOR flash memory), a hard driver, or a Solid State Drive (SSD). The external memory 933B may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 933B can be functionally and/or physically connected to the electronic device 931 through various interfaces. The sensor module 934 can, for example, measure a physical quantity or detect an operation state of the electronic device 931 to convert the measured or detected information to an electrical signal. The sensor module 934 may include at least one of, for example, a gesture sensor 934A, a gyro sensor 934B, an atmospheric pressure sensor 934C, a magnetic sensor 934D, an acceleration sensor 934E, a grip sensor 934F, a proximity sensor 934G, a color sensor 934H (for example, a Red/Green/Blue (RGB) sensor), a biometric sensor 934I, a temperature/humidity sensor 934J, an illumination sensor 934K, and an Ultra Violet (UV) sensor 934M. Additionally or alternatively, the sensor module 934 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 934 may further include a control circuit for controlling at least one sensor included therein. In any embodiment, the electronic device 931 may further include a processor configured to control the sensor module 934 as a part of or separately from the AP 932, and can control the sensor module 934 while the AP 932 is in a sleep state. The input device 935 may include, for example, a touch panel 935A, a (digital) pen sensor 935B, a key 935C, or an ultrasonic input device 935D. The touch panel 935A can use at least one of, for example, a capacitive type, a resistive type, an infrared type, and an ultrasonic type. The touch panel 935A may further include a control circuit. The touch panel 935A may further include a tactile layer, and provide a tactile reaction to a user. The (digital) pen sensor 935B may include, for example, a recognition sheet which is a part of the touch panel or a separate recognition sheet. The key 935C may include, for example, a physical button, an optical key or a keypad. The ultrasonic input unit 935D can input data through an input means that generates an ultrasonic signal, and the electronic device 931 can identify data by detecting a sound wave with a microphone (for example, a microphone 938D). The display 936 (e.g., the display 910) may include a panel 936A, a hologram device 936B, or a projector 936C. The panel 936A may include a component equal or similar to the display 910 of FIG. 4A. The panel 936A may be implemented to be, for example, flexible, transparent, or wearable. The panel 936A can also be configured to be integrated with the touch panel 1752 as a single module. The hologram device 936B can show a stereoscopic image in the air by using interference of light. The projector 936C may project light onto a screen to display an image. For example, the screen can be located inside or outside the electronic device 931. According to an embodiment, the display 936 may further include a control circuit for controlling the panel 936A, the hologram device 936B or the projector 936C. The interface 937 may include, for example, a High-Definition Multimedia Interface (HDMI) 937A, a Universal Serial Bus (USB) 937B, an optical interface 937C, or a D-subminiature (D-sub) 937D. The interface 937 may be included in, for example, the communication interface 910 illustrated in FIG. 4A. Additionally or alternatively, the interface 937 may include, for example, a Mobile High-definition Link (MHL) interface, a Secure Digital (SD) card/Multi-Media Card (MMC) interface, or an Infrared Data Association (IrDA) standard interface. The audio module 938 can bilaterally convert, for example, a sound and an electrical signal. At least some components of the audio module 938 may be included in, for example, the input/output interface 908 illustrated in FIG. 38. The audio module 938 can process sound information which is input or output through, for example, a speaker 938A, a receiver 938B, an earphone 938C, a microphone 938D or the like. The camera module 939 is a device which can photograph a still image and a moving image. According to an embodiment, the camera module 939 may include one or more image sensors (for example, a front sensor or a rear sensor), a lens, an Image Signal Processor (ISP) or a flash (for example, an LED or a xenon lamp). The power management module 942 can, for example, manage power of the electronic device 931. According to an embodiment, the power management module 942 may include a Power Management Integrated Circuit (PMIC), a charger Integrated Circuit (IC), or a battery or fuel gauge. The PMIC may have a wired and/or wireless charging scheme. Examples of the wireless charging method may include, for example, a magnetic resonance method, a magnetic induction method, an electromagnetic method, and the like, and may further include additional circuits (e.g., a coil loop, a resonance circuit, a rectifier, etc.) for wireless charging. The battery gauge can, for example, measure a residual amount of battery 943, a charging voltage and current, or temperature. The battery 943 may include, for example, a rechargeable battery and/or a solar battery. The indicator 940 can display a particular status of the electronic device 931 or a part thereof (for example, the AP 932), for example, a booting status, a message status, a charging status, or the like. The motor 941 can convert an electrical signal into mechanical vibrations, and can generate a vibration or haptic effect. Although not illustrated, the electronic device 931 may include a processing device (for example, a GPU) for supporting mobile TV. The processing device for supporting mobile TV can process media data according to a standard of Digital Multimedia Broadcasting (DMB), Digital Video Broadcasting (DVB), media flow or the like.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements.

Further, some of the components of the electronic device according to the various embodiments of the present disclosure may be combined to form a single entity, and thus, may equivalently execute functions of the corresponding elements prior to the combination.

FIG. 4C is a block diagram 950 illustrating a program module 951 according to various embodiments of the present disclosure. According to an embodiment, the program module 951 (for example, the program 908 in FIG. 4A) may include an Operating System (OS) for controlling resources related to the electronic device (for example, the electronic device 901 in FIG. 4A) and/or various applications (for example, the application program 916 in FIG. 4A) executed on the OS. The OS may be, for example, Android, iOS, Windows, Symbian, Tizen, Bada, or the like. The program module 951 may include a kernel 952, middleware 953, an API 954, and/or an application 955. At least some of the program module 951 may be preloaded on the electronic device or downloaded from a server (for example, the server 904 in FIG. 4A). The kernel 952 (e.g., the kernel 913 in FIG. 4A) may include, for example, a system resource manager 952A and/or a device driver 952B. The system resource manager 952A can control, allocate, or collect the system resources. According to an embodiment, the system resource manager 952A may include a process manager, a memory manager, or a file system manager. The device driver 952B may include, for example, a display driver, a camera driver, a Bluetooth driver, a shared-memory driver, a USB driver, a keypad driver, a Wi-Fi driver, an audio driver, or an Inter-Process Communication (IPC) driver. The middleware 953 can provide a function required by the applications 955 in common or provide various functions to the applications 955 through the API 954 so that the applications 955 can efficiently use limited system resources of the electronic device. According to an embodiment, the middleware 953 (e.g., the middleware 914 in FIG. 4A) may include, for example, at least one of a runtime library 953Z, an application manager 953A, a window manager 953B, a multimedia manager 953C, a resource manager 953D, a power manager 953E, a database manager 953F, a package manager 953G, a connectivity manager 953H, a notification manager 953I, a location manager 953J, a graphic manager 953K, and a security manager 953M. The run-time library 953Z may include, for example, a library module that a compiler uses in order to add new functions through a programming language while the application 955 is executed. The run-time library 953Z may perform input/output management, memory management, or a function for an arithmetic function. The application manager 953A can, for example, manage a life cycle of at least one application among the applications 955. The window manager 953B can manage GUI resources used on the screen. The multimedia manager 953C can identify a format required for reproduction of various media files, and can encode and decode the media file by using a COder/DECoder (CODEC) suitable for the corresponding format. The resource manager 953D can manage resources such as a source code, a memory, or a storage space of at least one of the applications 955. The power manager 953E can operate together with, for example, a Basic Input/Output System (BIOS), so as to manage a battery or power and can provide power information required for the operation of the electronic device. The database manager 953F may generate, search for, or change a database to be used by at least one of the applications 955. The package manager 953G can manage installation or an update of an application distributed in a form of a package file. For example, the connectivity manager 953H can manage wireless connections such as Wi-Fi or Bluetooth. The notification manager 953I can display or notify of an event such as an arrival message, an appointment, proximity notification, and the like in such a manner that a user is not disturbed. The location manager 953J can manage location information of the electronic device. The graphic manager 953K can manage a graphic effect to be provided to a user and a user interface related to the graphic effects. The security manager 953M may provide various security functions required for system security or user authentication. According to an embodiment, when the electronic device (for example, electronic device 901 in FIG. 4A) has a call function, the middleware 953 may further include a telephony manager for managing a voice call function or a video call function of the electronic device. The middleware 953 may include a middleware module for forming a combination of various functions of the aforementioned components. The middleware 953 may provide a module specialized for each type of operating system in order to provide a differentiated function. In addition, a few existing components may be dynamically removed from the middleware 953, or new components may be added to the middleware 230. The API 954 (for example, the API 915 in FIG. 4A), which is a set of API programming functions, can be provided in a different configuration for each operating system. For example, in the case of Android or iOS, one API set may be provided for each platform. In the case of Tizen, two or more API sets may be provided for each platform. The application 955 (e.g., the application program 916 in FIG. 4A) may include, for example, one or more applications which can provide functions such as a home function 955A, a dialer 955B, an SMS/MMS 955C, an Instant Message (IM) 955D, a browser 955E, a camera 955F, an alarm 955G, a contact 955H, a voice dialer 955I, an E-mail 955J, a calendar 955K, a media player 955L, an album 955M, a clock 955N, a health care (e.g., measurement of exercise quantity or blood sugar), or provision of environment information (e.g., atmospheric pressure, humidity, or temperature information). According to an embodiment, the applications 955 may include an application (hereinafter, referred to as an “information exchange application” for convenience of description) supporting information exchange between the electronic device (e.g., the electronic device 901 in FIG. 4A) and an external electronic device (e.g., the electronic device 902 or 903 in FIG. 4A). The information exchange application may include, for example, a notification relay application for transmitting specific information to the external electronic device, or a device management application for managing the external electronic device. For example, the notification relay application may include a function of transferring, to the external electronic device (for example, the electronic device 902 or 903), notification information generated by other applications of the electronic device 101 (for example, an SMS/MMS application, an E-mail application, a health management application, or an environmental information application). Further, the notification relay application can, for example, receive notification information from the external electronic device and provide the received notification information to a user. The device management application may, for example, manage (e.g., install, delete, or update) at least one function of the external electronic device (e.g., the electronic devices 102 and 104) communicating with the electronic device (e.g., turning on/off the external electronic device itself (or some elements thereof) or adjusting brightness (or resolution) of a display), applications executed in the external electronic device, or services provided from the external electronic device (e.g., a telephone call service or a message service). According to an embodiment, the applications 955 may include an application (for example, a health management application) designated according to attributes (for example, attributes of the electronic device such as the type of electronic device which corresponds to a mobile medical device) of the external electronic device (for example, the electronic device 902 or 903 in FIG. 4A). According to an embodiment, the applications 955 may include an application received from the external electronic devices (e.g., the server 904 in FIG. 4A) or the electronic device 902 or 903 in FIG. 4A. According to an embodiment, the applications 955 may include a preloaded application or a third party application which can be downloaded from the server. Names of the elements of the program module 951, according to the above-described embodiments of the present disclosure, may change depending on the type of OS. According to various exemplary embodiments of the present disclosure, at least some of the program module 951 may be implemented in software, firmware, hardware, or a combination of two or more thereof. At least some of the programming module 951 may be implemented (for example, executed) by, for example, the processor (for example, the AP 932). At least some of the programming module 951 may include, for example, a module, program, routine, sets of instructions, process, or the like for performing one or more functions.

The term “module” used in various embodiments of the present disclosure may refer to, for example, a “unit” including one of hardware, software, and firmware, or a combination of two or more of the hardware, software, and firmware. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 906 in FIG. 4A), the one or more processors may execute a function corresponding to the command. The computer-readable storage medium may be, for example, the memory (907 in FIG. 4A). The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa. The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1. A method for a distributed interactive processor-controlled graphical user interface (GUI) display with a user input device to visually and dynamically display the status of a commercial transaction between two parties, where said transaction includes electronic transmission of documents, said GUI displaying differently based on the transacting party, said method comprising the steps of:
dynamically displaying a list of requisite documents for a transaction and the present status of receipt and modification of each said document;
directing a user action by providing a party with a fillable electronic form, displaying fillable options in real time, and dynamically updating the display to reflect user input to said form;
based on said user input, preparing and delivering a query for delivery to a third party and correspondingly dynamically updating the progress of said transaction on said display; and
upon receiving a response to said query, dynamically indicating receipt of said response, analyzing the response content and dynamically indicating further progress of the transaction based on said response content;
wherein said distributed GUI provides for different views and allowable actions based at least on type of user and said GUI provides for acceptance of electronic signature at least once all steps are deemed to have been completed.

2. The method of claim 1, wherein the steps of preparing and delivering, dynamically indicating, and analyzing are repeated until all requisite documents are received.

3. The method of claim 2, wherein upon determining said process flow is complete, delivering completed documents to the relevant parties for signature.

4. The method of claim 1, wherein said GUI stores received documents in a data store.

5. The method of claim 1, wherein additional content for completion of said transaction is determined at least in part by comparison of entered data with data obtained from a database, said database contacted by query.

6. The method of claim 1, where said GUI is customizable based on the type of commercial transaction.

7. A method for a processor, in communication with a distributed GUI, to amass requisite materials for a commercial transaction including selective electronic transmission of documents, where said GUI provides means for entry of content by user and displays status relative to a pre-set process flow, said display customized to a user, said method comprising the steps of:
providing within said GUI a tillable form for entry by a first party;
dynamically updating the GUI, said GUI customized to the viewing party;
based on the content obtained from said fillable form, querying a third-party as to the accuracy of the data entered by the user so as to obtain at least one document relative to said content;
upon receiving a document in response, dynamically updating said GUI display, storing said document in an accessible data store, electronically analyzing the content of said document, and further updating said GUI display based on said analysis;
determining, on the basis of said analysis, a second query to obtain additional information; and
upon receiving a document in response to said second query, dynamically updating said GUI display, storing said document in an accessible data store, electronically analyzing the content of said document, and further updating said GUI display based on said analysis;
wherein said GUI is usable by authorized parties to access stored responses.

8. The method of claim 7, wherein said process flow is automatically revised based on at least one received response to a query and analyzed content of said response.

9. The method of claim 8, wherein the steps of querying, analyzing, and dynamically updating are repeated until all steps in said process flow are completed.

10. The method of claim 7, wherein upon completion of pre-determined process points, said GUI affords users an opportunity to electronically sign at least one document.

11. The method of claim 7, wherein options in said GUI provide for access to content in said database.

12. The method of claim 7, wherein said content is determined at least in part by comparing said entered data in said electronic fillable form with data in a database, said database contacted by query.

13. The method of claim 7, where said GUI is customizable based on the type of commercial transaction.

14. A system for automatedly preparing materials for closing of a commercial transaction and dynamically displaying status on at least one GUI comprising:
a data store for storing documents in electronic form and in communication with said server;
a first user's GUI operating on a first user's processor-controlled workstation and in communication with said server;
a second user's GUI operating on a second user's processor-controlled workstation and in communication with said server; and
a server for analyzing the content of documents and delivering instruction and status to a plurality of GUIs wherein said server
directs said GUIs to dynamically display real time status relative to a potential transaction's required materials;
administers a flow for transaction completion, said flow initially pre-set;
adjusts said flow based on documents and text received and their content;
delivers a fillable information sheet for completion by a user;
compares information entered on the information sheet with that of existing databases;
determines contents for inclusion in a query for delivery to a third party and prepares and delivers said query; and
receives a response to said query, analyzing content of said response and correspondingly dynamically updating said displays and said flow.

15. The system of claim 14, wherein the server functions of delivering, comparing, analyzing, determining, selecting and dynamically updating are repeated until all steps in said process flow are completed.

16. The system of claim 14, wherein said process flow is adjusted based on said received responses to said queries and analyzed content of said responses.

17. The system of claim 14, wherein said information sheet is fillable with content selectable by a user upon entering data in a fillable field.

18. The system of claim 14, wherein said content is determined at least in part by comparing entered data with data in a database, said database contacted by query.

19. The system of claim 14, where at least one GUI is customizable based on the type of commercial transaction.

20. The system of claim 14, where said transaction is a loan.
